(19) United States
(12) Patent Application Publication
(10) Pub. No.: US 2015/0104739 A1
(43) Pub. Date: Apr. 16, 2015

(54) TONER, DEVELOPER, AND IMAGE FORMING APPARATUS

(71) Applicants: Tsuneyasu Nagatomo, Shizuoka (JP); Satoshi Kojima, Shizuoka (JP); Syouko Satoh, Kanagawa (JP); Kiwako Hirohara, Kanagawa (JP); Osamu Uchinokura, Shizuoka (JP); Junichi Awamura, Shizuoka (JP); Satoshi Ogawa, Nara (JP); Takahiro Honda, Shizuoka (JP)

(72) Inventors: Tsuneyasu Nagatomo, Shizuoka (JP); Satoshi Kojima, Shizuoka (JP); Syouko Satoh, Kanagawa (JP); Kiwako Hirohara, Kanagawa (JP); Osamu Uchinokura, Shizuoka (JP); Junichi Awamura, Shizuoka (JP); Satoshi Ogawa, Nara (JP); Takahiro Honda, Shizuoka (JP)

(21) Appl. No.: 14/384,490

(22) PCT Filed: Mar. 7, 2013
(86) PCT No.: PCT/JP2013/057112

§ 371 Date: Sep. 11, 2014

(30) Foreign Application Priority Data
Mar. 14, 2012 (JP) 2012-057365

(51) Int. Cl. G03G 9/00

(52) U.S. Cl. CPC G03G 9/08755; G03G 9/0819
USPC 430/105; 430/108.7; 430/109.4

(57) ABSTRACT

A toner, containing: toner base particles; and an external additive, the toner base particles each including a binder resin and a releasing agent, wherein the external additive includes non-spherical coalesced particles in each of which primary particles are coalesced together, and wherein the coalesced particles satisfy the following formula (1): Nx/1,000×100≦30% where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

### TECHNICAL FIELD

The present invention relates to a toner, which is used in image formation performed by an electrophotographic system, such as by a photocopier, electrostatic printing, a printer, a facsimile, and electrostatic recording, and also relates to a developer and image forming apparatus using the toner.

### BACKGROUND ART

In recent years, it is possible to perform high-speed image formation in the technical field of electrophotographic image formation. In addition, competitions in developing a color image forming apparatus that gives high image quality have been severe. To provide a full-color image at high speed, a tandem system is commonly employed. The tandem system is a system of an image forming apparatus, where a plurality of electrophotographic photoconductors are aligned in series, an image of each color is formed on each electrophotographic photoconductor, and the images of different colors are superimposed on an intermediate transfer member, and then collectively transferred to a recording medium.

For the purpose of preventing a background deposition on an electrophotographic photoconductor in the tandem image forming apparatus during developing, proposed is a method for preventing background deposition to be transferred from an intermediate transfer member directly to a recording medium, such as paper (see, for example, PTL 1 and PTL 2). However, there are a problem with such method that the transfer property is not sufficiently desirable because there are two transferring steps to be performed, namely a transferring step (primary transfer) from the electrophotographic photoconductor to the intermediate transfer member, and a transferring step (secondary transfer) from the intermediate transfer member to a recording medium for providing a final image.

In addition to the need to solve the aforementioned problem of low transfer property, higher image quality has been desired. To this end, a toner has been down-sized, and accurate reproduction of a latent image has been considered. To down-sizing particle diameters of particles consisting a toner, proposed is a method for producing a toner using a polymerization method (see, for example, PTL 3 and PTL 4). With this method, toner particles can be controlled to have desirable particle diameters, shapes, and surface structures, a piled height (a thickness of an image layer) is kept small, and excellent reproducibility of dots and fine lines can be achieved. In the case where the toner of a small particle size is used, however, non-electrostatic adhesion force between the toner particles to the electrophotographic photoconductor, and non-electrostatic adhesion force between the toner particles to the intermediate transfer member increase, and therefore transfer property of the toner is deteriorated. When the toner having a small particle size is used especially in a high-speed full-color image forming apparatus, reduction in the transfer property of the toner becomes significant at the secondary transfer. This is because, with the toner having a small particle size, non-electrostatic adhesion force per particle to the intermediate transfer member increases, and a period that the toner particles receive transfer electric field at a secondary nip is short as a result of high-speed transfer.

As a method for solving the low transfer property, considered is increasing transfer electric field for secondary transfer. However, the transfer property is degraded even more as the transfer electric field is increased. To prevent deterioration of transfer property, considered is to prolong the time that the toner particles receive transfer electric field by widening a width of a secondary transfer nip. In case of a contact voltage applying system, however, a resulting image quality is degraded, as a contact pressure of a bias roller increases, and moreover use of a bias roller having an enlarged roller diameter is not suitable for a down-sized roller device. In case of the non-contact voltage applying system, there is a limit to increase the number of chargers. Especially in a high-speed device, it is substantially impossible to widen a nip width to achieve desirable transfer property.

As another method for solving the low transfer property, proposed is a method for adjusting a type or amount of an external additive (see, for example, PTL 5). In accordance with this method, use of the external additive having a large particle size can reduce non-electrostatic adhesion force of toner particles, to thereby improve transfer property, developing stability, and cleaning property. However, an effect for improving flowability of a toner becomes small, which may cause filming, and carrier pollution, or impair supplying property of a toner. Moreover, even through high quality images may be output initially, the external additive may be embedded in toner base particles by the stirring stress applied to the toner in a developing device after the usage of a long period. Since the motions of the stirring in a developing device is strong especially in a high-speed device, the embodiment of the external additive into the toner base particles tends to be accelerated, and therefore transfer property is deteriorated in a relatively early stage.

In order to maintain stable and high transfer property over a long period, it is desirable to control a surface property (physical strength) of a toner, so as not to embed the external additive into the toner base particles. Excessively enhanced surface property of the toner (excessively hard surface of the toner) impairs melting of the toner during fixing, and therefore bleeding of the releasing agent to a fixing roller becomes insufficient, which impairs fixing ability of the toner. Further, a treatment for merely making toner particles spherical impairs cleaning property of the toner. Therefore, propose is use of a crystalline polyester resin, which is synthesized by a polymerization, as a binder resin contained in a toner (see, for example, PTL 6). However, the toner using the crystalline polyester resin has a problem that an external additive tends to be embedded into surfaces of particles of the toner, and transfer property of the toner is deteriorated.

For the purpose of improving the transfer property, proposed is use of a non-spherical external additive (see, for example, PTL 7). With the non-spherical external additive, excellent image density can be achieved at initial printing, but the storage stability of the toner is poor, and therefore the image density is lowered as printing is continuously performed for a long period, and the durability of the toner is poor. Moreover, whether the non-spherical particles are cracked and/or collapsed by externally applied loads is not discussed therein, and therefore the aforementioned method is not sufficient.

Accordingly, there is currently a need for promptly developing a toner, which has high durability such that the toner excels in cleaning ability, storage stability, and image density when used for a long period, as well as having excellent transfer property in high-speed full-color image formation.

### CITATION LIST

### Patent Literature

PTL 1: Japanese Patent Application Laid-Open (JP-A) No. 11-073025

PTL 2: JP-A No. 2000-122355

PTL 3: JP-A No. 11-174731

PTL 4: JP-A No. 2005-173480

PTL 5: Japanese Patent (JP-B) No. 3684074

PTL 6: JP-A No. 08-176310

PTL 7: JP-A No. 2010-243664

### SUMMARY OF INVENTION

### Technical Problem

The present invention has been accomplished based upon the aforementioned current situation to solve the various problems in the art, and aims to achieve the following object. An object of the present invention is to provide a toner having high durability such that the toner excels in cleaning ability, storage stability, and image density when used for a long period, as well as having excellent transfer properties in high-speed full-color image formation.

### Solution to Problem

The means for solving the aforementioned problems are as follows:

The toner of the present invention contains:

toner base particles, each containing at least a binder resin and a releasing agent; and

an external additive,

wherein the external additive contains non-spherical coalesced particles in each of which primary particles are coalesced together, and

wherein the coalesced particles satisfy the following formula (1):

$$\frac{Nx}{1 , 000} \times 100 \leq 30 \% \qquad Formula ( 1 )$$

where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

### Advantageous Effects of Invention

The present invention can solve the various problems in the art, and can provide a toner having high durability such that the toner excels in cleaning ability, storage stability, and image density when used for a long period, as well as having excellent transfer properties in high-speed full-color image formation.

### BRIEF DESCRIPTION OF DRAWINGS

FIG. 1 is a photograph depicting an example of the external additive of the toner of the present invention.

FIG. 2 is a photograph depicting an example of the external additive of the toner of the present invention.

FIG. 3 is a photograph depicting one example of an evaluation result of the external additive of Example.

FIG. 4 is a photograph depicting one example of an evaluation result of the external additive of Comparative Example.

FIG. 5 is a schematic diagram for explaining one example of a process cartridge suitable for use in the image forming apparatus of the present invention.

FIG. 6 is a schematic diagram for explaining one example of the image forming apparatus of the present invention.

FIG. 7 is a schematic diagram for explaining another example of the image forming apparatus of the present invention.

FIG. 8 is a schematic diagram for explaining yet another example of the image forming apparatus of the present invention.

FIG. 9 is a schematic diagram for explaining one part of the image forming apparatus illustrating in FIG. 8.

### DESCRIPTION OF EMBODIMENTS

### (Toner)

The toner of the present invention contains at least toner base particles, and an external additive, and may further contain other components, if necessary.

### <External Additive>

The external additive contains at least coalesced particles, and may further contain other external additives, other than the coalesced particles, if necessary.

### —Coalesced Particles—

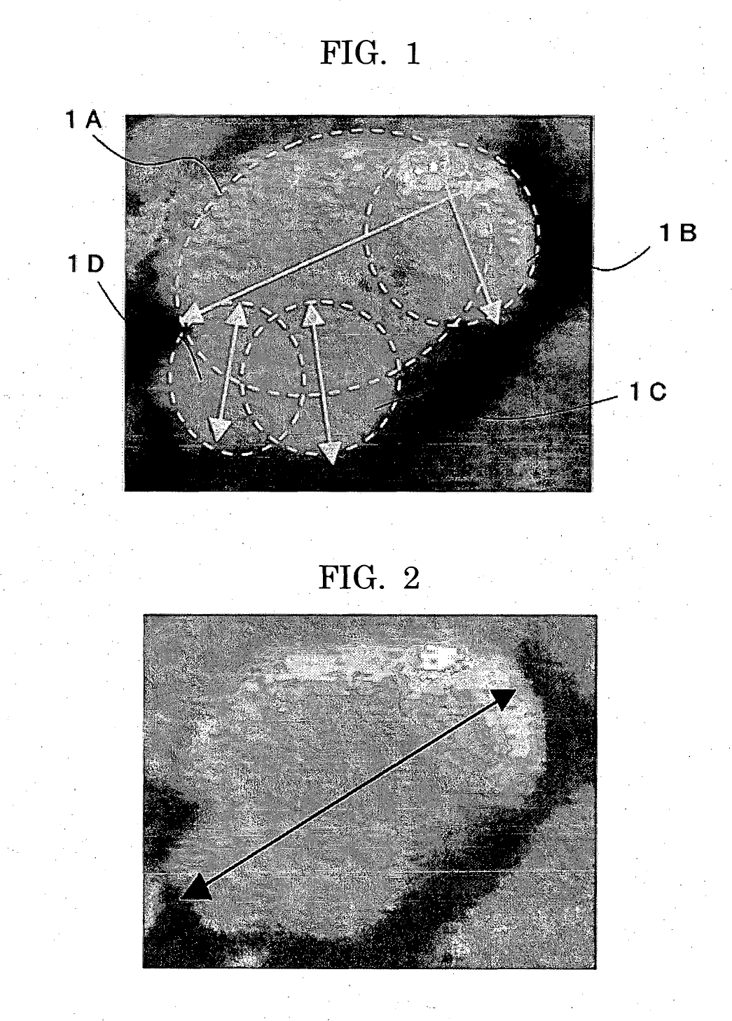

The coalesced particles are each a non-spherical particle in each of which primary particles are coalesced together, and are namely secondary particles formed by coalescencing (aggregating) a plurality of primary particles (1A to 1D), as illustrated in FIG. 1. Note that, the “coalesced particle(s)” may be referred to as “secondary particle(s)” hereinafter.

### ——Primary Particle——

The primary particles are appropriately selected depending on the intended purpose without any limitation, and examples thereof include inorganic particles (e.g., silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride), and organic particles. These may be used alone or in combination. Among them, silica is preferable.

### ——Secondary Particle——

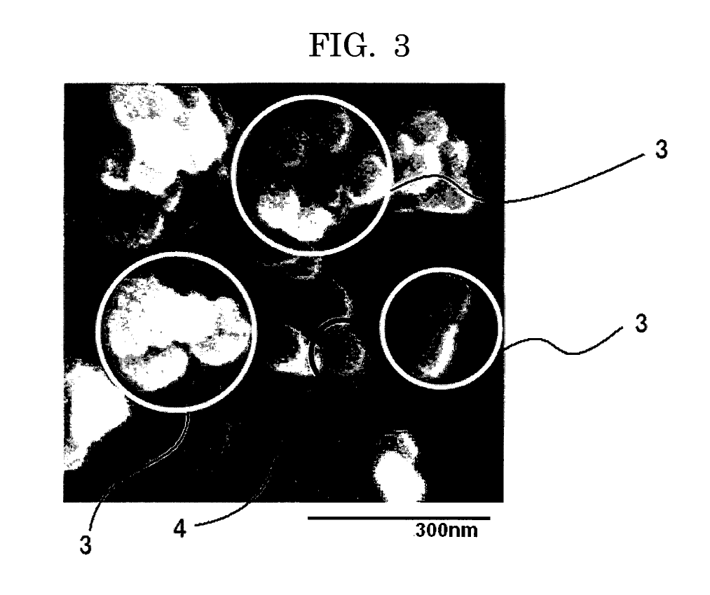

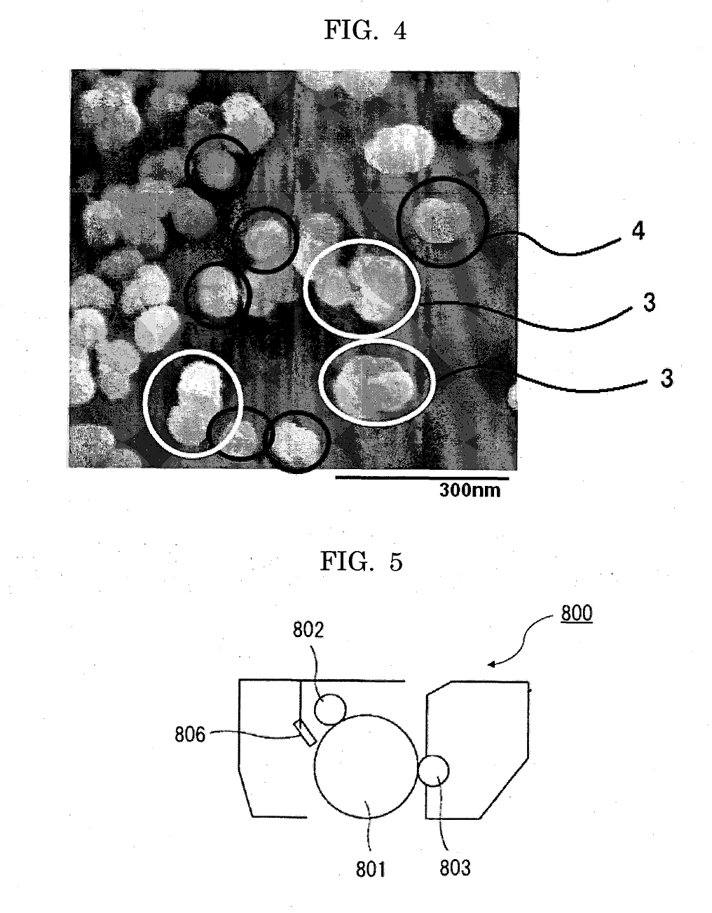

The secondary particles are appropriately selected depending on the intended purpose without any limitation, but they are preferably particles (secondary aggregated particles) each formed by chemically bonding the aforementioned primary particles with the below-mentioned treatment agent, such as the particle indicated with the reference number 3 in FIGS. 3 and 4, more preferably particles each formed by chemically bonding the primary particles by a sol-gel method.

The average particle diameter of the secondary particles, i.e., the average particle diameter of the coalesced particles, is appropriately selected depending on the intended purpose without any limitation, but it is preferably 15 nm to 400 nm, more preferably 20 nm to 300 nm, and even more preferably 50 nm to 200 nm. When the average particle diameter thereof is smaller than 15 nm, the external additive tends to be embedded in the toner base particle, and therefore sufficient durability of the toner cannot be maintained, which may lead to insufficient cleaning ability. When the average particle diameter thereof is greater than 400 nm, an excessive amount of the external additive is deposited on the toner base particle, and therefore the external additive is easily detached from the toner base particle so that it may not be able to maintain the transfer property of the toner.

The measurement of the average particle diameter of the secondary particles is performed by dispersing the secondary particles in an appropriate solvent (e.g., THF), removing and drying the solvent on a substrate to prepare a sample, observing the sample and measuring particle diameters of the secondary particles in a visual field under a field emission scanning electron microscope (FE-SEM, accelerating voltage: 5 kV to 8 kV, magnification: ×8,000 to ×10,000). Specifically, the average particle diameter of the secondary particles is determined by speculating an entire image from a profile of the secondary particle formed by coalescence, and measuring the average value (the number of particles measured: 100 particles or more) of the maximum length (a length of the arrow shown in FIG. 2) of the entire image.

### —Production Method of Coalesced Particles—

A production method of the coalesced particles is appropriately selected depending on the intended purpose without any limitation, but it is preferably a production method using a sol-gel method. Specifically, preferred is a method containing mixing and/or firing primary particles together with a treatment agent to secondary aggregate by chemical bonding, to thereby produce secondary particles (coalesced particles). Note that, in the case where the coalesced particles are synthesized by the sol gel method, coalesced particles may be prepared in a single stage reaction by allowing the treatment agent present together. One example of the production method is described below, but the production method is not limited thereto.

### ——Treatment Agent——

The treatment agent is appropriately selected depending on the intended purpose without any limitation, and examples thereof include a silane-based treatment agent, and an epoxy-based treatment agent. These may be used alone or in combination. In the case where silica is used as the primary particle, the silane-based treatment agent is preferably used because a Si—O—Si bond the silane-based treatment agent forms is more stable to heat than a Si—O—C bond the epoxy-based treatment agent forms. Moreover, a treatment aid (e.g., water, and a 1% by mass acetic acid aqueous solution) may be used, as needed.

### ———Silane-Based Treatment Agent———

The silane-based treatment agent is appropriately selected depending on the intended purpose without any limitation, and examples thereof include: alkoxy silane (e.g., tetramethoxy silane, tetraethoxy silane, methyltrimethoxy silane, methyltriethoxy silane, dimethyldimethoxy silane, dimethyldiethoxy silane, methyldimethoxy silane, methyldiethoxy silane, diphenyldimethoxy silane, isobutyltrimethoxy silane, and decyltrimethoxy silane); a silane coupling agent (e.g., γ-aminopropyltoluethoxy silane, γ-glycidoxypropyltrimethoxy silane, γ-glycidoxypropylmethyldiethoxy silane, γ-methacryloxypropyltrimethoxy silane, γ-mercaptopropyltrimethoxy silane, vinyltriethoxy silane, and methylvinyldimethoxy silane); and a mixture of any of compounds, such as vinyltrichlorosilane, dimethyldichlorosilane, methylvinyldichlorosilane, methylphenyldichlorosilane, phenyltrichlorosilane, N,N′-bis(trimethylsilyl)urea, N,O-bis(trimethylsilyl)acetoamide, dimethyltrimethylsilylamine, hexamethyl disilazane, and cyclic silazane.

The silane-based treatment agent forms secondary aggregations of the primary particles (e.g., silica primary particles) with a chemical bond in the following manner.

In the case where the silica primary particles are treated with the alkoxy silane or the silane-based coupling agent as the silane-based treatment agent, as represented by the following formula (A), a silanol group bonded to the silica primary particle reacts with an alkoxy group bonded to the silane-based treatment agent to form a new Si—O—Si as a result of the alcohol elimination reaction, to thereby cause secondary aggregation.

In the case where the silica primary particles are treated with the chlorosilane as the silane-based treatment agent, a chloro group of the chlorosilane and a silanol group bonded to the silica primary particle proceed to a dehydrochlorination reaction, and as a result, the silanol group for forming a new Si—O—Si bond forms a new Si—O—Si bond as a result of a dehydration reaction, to thereby cause secondary reaction. Moreover, in the case where the silica primary particles are treated with the chlorosilane as the silane-based treatment agent and water is present in the system, first, the chlorosilane and water proceed to hydrolysis to generate a silanol group, and the generated silanol group and a silanol group bonded to the silica primary particle form a new Si—O—Si bond as a result of a dehydration reaction, to thereby cause secondary aggregation.

In the case where the silica primary particles are treated with the silazane as the silane-based treatment agent, an amino group and a silanol group bonded to the silica primary particle proceed to an ammonia elimination reaction to form a new Si—O—Si bond, to thereby cause secondary aggregation.

—Si—OH+RO-Si—→—Si—O—Si—+ROH Formula (A)

In the formula (A) above, R denotes an alkyl group.

### ———Epoxy-Based Treatment Agent———

The epoxy-based treatment agent is appropriately selected depending on the intended purpose without any limitation, and examples thereof include a bisphenol A epoxy resin, a bisphenol F epoxy resin, a phenol novolak epoxy resin, a cresol novolak epoxy resin, a bisphenol A novolak epoxy resin, a bisphenol epoxy resin, a glycidylamine epoxy resin, and an alicyclic epoxy resin.

The epoxy-based treatment agent forms secondary aggregations of the primary particles (e.g., silica primary particles) with a chemical bond, as represented by the following formula (B). In the case where the silica primary particles are treated with the epoxy-based treatment agent, a silanol group bonded to the silica primary particle carries out an addition reaction to add an oxygen atom of an epoxy group and a carbon atom bonded to the epoxy group of the epoxy-based treatment agent to form a new Si—O—C bond, which causes secondary aggregation of the primary particles.

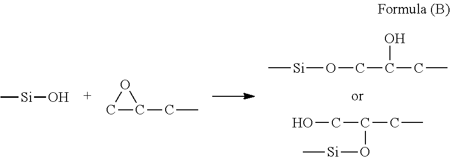

A blending mass ratio of the primary particle to the treatment agent (primary particle: treatment agent) is appropriately selected depending on the intended purpose without any limitation, but it is preferably 100:0.01 to 100:50. Note that, as an amount of the treatment agent increases, the degree of coalescence tends to increase.

A method for mixing the primary particles with the treatment agent is appropriately selected depending on the intended purpose without any limitation, and examples thereof include a method for mixing by means of a conventional mixer (e.g., a spray dryer). Upon mixing, the treatment agent may be mixed after the primary particles are prepared, or the treatment agent may be added and in present during the primary particles are prepared to thereby perform the preparation with a single stage reaction.

The firing temperature of the primary particles and the treatment agent is appropriately selected depending on the intended purpose without any limitation, but it is preferably 100° C. to 2,500° C. Note that, the degree of coalescence increases as the firing temperature increases.

The firing time of the primary particles and the treatment agent is appropriately selected depending on the intended purpose without any limitation, but it is preferably 0.5 hours to 30 hours.

### ——Parameters of Coalesced Particles——

The coalesced particles are appropriately selected depending on the intended purpose without any limitation, as long as they satisfy the following formula (1), but they also preferably satisfy the following formula (1-1).

The coalesced particles improve durability of the toner because the coalesced particles maintain the aggregation force (coalescence force) between the primary particles under a certain stirring condition.

$$\begin{matrix}\frac{Nx}{1 , 000} \times 100 \leq 30 \% & Formula ( 1 ) \\ \frac{Nx}{1 , 000} \times 100 \leq 20 \% & Formula ( 1 \text{-} 1 )\end{matrix}$$

In Formulae (1) and (1-1), Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

The present inventors have attained the following insights based upon the researches the inventors conducted.

Namely, one of the insights is that the toner lowers the durability thereof, when the coalesced particles of the external additive contained in the toner are crashed and/or collapsed, as loads are externally applied, to thereby turn back to the primary particles. Therefore, it was studied not to crack or collapse the coalesced particles of the external additive, which lead to another insight. That is, the durability of the toner can be enhanced by using particles having certain durability as an external additive.

In the case where the cohesive power of the coalesced particles is strong (e.g., the case where the ratio of the primary particles present alone [the reference number 4, in FIG. 3] relative to 1,000 coalesced particles is 30% or lower, as illustrated in FIG. 3), the number of the coalesced particles turned back to the primary particles due to cracking and or collapse caused by loads applied in a developing device is reduced, and therefore embedding or rolling of the external additive is prevented and a high transferring rate of the toner can be maintained over time.

In the case where the cohesive power of the coalesced particles is weak (e.g., the case where the ratio of the primary particles present alone [the reference number 4, in FIG. 4] relative to 1,000 coalesced particles is greater than 30%, as illustrated in FIG. 4), the number of the coalesced particles turned back to the primary particles due to cracking and or collapse caused by loads applied in a developing device is increased, which increases a proportion of the spherical primary particles. Therefore, rolling or embedding of the external additive tends to occur, and a high transferring rate of the toner is difficult to maintain over time.

### ———Conditions of Formula (1) ———

In the formula (1), the primary particles means particles that are not coalesced to other primary particles after stirring the coalesced particles by the mixing and stirring device under the aforementioned stirring conditions, and include particles which are became primary particles by crack or collapse of the coalesced particles after the stirring, and particles which are present as primary particles before the stirring. For example, the primary particles include particles that are not coalesced to other primary particles, such as the particles indicated with the reference number 4 in FIGS. 3 and 4.

In the formula (1), shapes of the primary particle are appropriately selected depending on the intended purpose without any limitation, provided that they are shapes which primary particles are not coalesced to each other. For example, as the particles indicated with the reference number 4 in FIGS. 3 and 4, the primary particles are commonly present in the substantially spherical state.

In the formula (1), a method for confirming how the primary particles are present is appropriately selected depending on the intended purpose without any limitation, but preferred is a method in which the primary particles are observed under a scanning electron microscope (SEM) to confirm that the primary particles are present alone.

A method for measuring the average particle diameter of the primary particles is appropriately selected depending on the intended purpose without any limitation. For example, the average particle diameter thereof is measured by measuring the average value of the particle diameters of the primary particles (the number of particles measured: 100 particles or more) in the visual field as observed under a scanning electron microscope (FE-SEM, accelerating voltage: 5 kV to 8 kV, magnification: ×8,000 to ×10,000).

In the measurement of the number of the primary particles present alone relative to the 1,000 coalesced particles associated with the formula (1), the particles are observed after the stirring, and a particle present alone, as the particles indicated with the reference number 4 in FIGS. 3 and 4, is counted as one primary particle.

When a coalesced particle which is formed by coalescencing a plurality of particles is confirmed by the observation under the scanning electron microscope, such coalesced particle is counted as one coalesced particle.

In the formula (1), a method for measuring the number of the primary particles present alone relative to the 1,000 coalesced particles is, for example, as follows. The coalesced particles and primary particles are observed under the scanning electron microscope with the particle concentration and observation magnification enable to distinguish a profile of each of the coalesced and primary particles. The number can be determined as a number of the primary particles relative to 1,000 coalesced particles in the observing field. As for the observing field, for example, the predetermined few visual fields or regions under the scanning electron microscope, preferably adjacent few visual fields or regions, can be appropriately set so that the number of the coalesced particles observed is to be 1,000 or more.

In the formula (1), as for the mixing and stirring device, ROKING MILL (manufactured by SEIWA GIKEN Co., Ltd.) is used.

In the formula (1), the carrier is appropriately selected depending on the intended purpose without any limitation, but preferred is a coated ferrite powder obtained by applying an acrylic resin-silicone resin coating layer forming solution containing alumina particles to surfaces of a baked ferrite powder, and drying the coated solution.

In the formula (1), the 50 mL bottle is appropriately selected depending on the intended purpose without any limitation, and examples thereof include a commercially available glass bottle (manufactured by NICHIDEN-RIKA GLASS CO., LTD.).

### ——Properties of Coalesced Particles——

An average of degrees of coalescence (the particle diameter of secondary particles/the average particle diameter of primary particles) of the coalesced particles is appropriately selected depending on the intended purpose without any limitation, but it is preferably 1.5 to 4.0. When the average of degrees of coalescence is less than 1.5, the external additive tends to roll into recesses formed in surfaces of the toner base particles, and therefore excellent transfer property of a toner may not be achieved. When the average of degrees of coalescence is greater than 4.0, the external additive tends to be detached from the toner, the carrier may be contaminated with the external additive, or the external additive may damage the photoconductor, which may cause image defects over time.

A method for confirming whether primary particles are coalesced to each other in the coalesced particles is appropriately selected depending on the intended purpose without any limitation, but preferred is a method for confirming whether primary particles are coalesced to each other in the coalesced particles by observing the coalesced particles under a scanning electron microscope (SEM).

Use of the coalesced particles contributes high flowability of the toner, and prevents the external additive from being embedded or rolled even when load is applied to the toner, such as by being stirred in a developing device, and therefore high transferring rate of the toner can be maintained.

—External Additive Other than Coalesced Particles—

Other external additives for use than the coalesced particles are appropriately selected from external additives known in the art depending on the intended purpose without any limitation, and examples thereof include those listed as the primary particles in the description for the coalesced particles.

An amount of the external additive is appropriately selected depending on the intended purpose without any limitation, but it is preferably 0.1 parts by mass to 5.0 parts by mass relative to 100 parts by mass of the toner base particles.

### <Toner Base Particle>

The toner base particles contain at least a binder resin and a releasing agent.

The toner base particles are preferably formed by the method containing: dissolving or dispersing at least the binder resin and the releasing agent in an organic solvent to prepare a solution or dispersion; adding the solution or dispersion to an aqueous phase to prepare a dispersion solution; and removing the organic solvent from the dispersion liquid, and more preferably formed by the method containing: adding the solution or dispersion to an aqueous phase to proceed to a crosslink or elongation reaction; and removing the organic solvent from the obtained dispersion liquid.

### <<Binder Resin>>

The binder resin is appropriately selected depending on the intended purpose without any limitation, and examples thereof include a polyester resin, a silicone resin, a styrene-acryl resin, a styrene resin, an acrylic resin, an epoxy resin, a diene-based resin, a phenol resin, a terpene resin, a coumarin resin, an amide-imide resin, a butyral resin, a urethane resin, and a vinylethylene acetate resin. These may be used alone or in combination. Among them, preferred are a polyester resin, and a combination of a polyester resin with any of the above-listed binder resin exclusive of the polyester resin, because these have sufficient flexibility with the small molecular weight thereof. Moreover, a crystalline resin is preferable as a resulting toner has excellent low temperature fixing ability and form a smooth image surface.

### —Polyester Resin—

The polyester resin is appropriately selected depending on the intended purpose without any limitation, but it is preferably an unmodified polyester resin, or a modified polyester resin. These may be used alone or in combination.

### ——Unmodified Polyester Resin——

The unmodified polyester resin is appropriately selected depending on the intended purpose without any limitation, and examples thereof include a polyester resin formed from polyol represented by the following general formula, and polycarboxylic acid represented by the following general formula (2).

A-[OH]ₘ General Formula (1)

B-[COOH]ₙ General Formula (2)

In the general formula (1) above, A denotes a C1-C20 alkyl group, an alkylene group, an aromatic group that may have a substituent, or a heterocyclic aromatic group; and m denotes an integer of 2 to 4.

In the general formula (2), B denotes a C1-C20 alkyl group, an alkylene group, an aromatic group that may have a substituent, or a heterocyclic aromatic group; and n is an integer of 2 to 4.

The polyol represented by the general formula (1) is appropriately selected depending on the intended purpose without any limitation, and examples thereof include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, polytetramethylene glycol, sorbitol, 1,2,3,6-hexanetetraol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylol ethane, trimethylol propane, 1,3,5-trihydroxymethyl benzene, bisphenol A, bisphenol A ethylene oxide adduct, bisphenol A propylene oxide adduct, hydrogenated bisphenol A, hydrogenated bisphenol A ethylene oxide adduct, and hydrogenated bisphenol A propylene oxide adduct. These may be used alone or in combination.

The polycarboxylic acid represented by the general formula (2) is appropriately selected depending on the intended purpose without any limitation, and examples thereof include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, iso-octyl succinic acid, iso-dodecenyl succinic acid, n-dodecyl succinic acid, iso-dodecyl succinic acid, n-octenyl succinic acid, n-octyl succinic acid, iso-octenyl succinic acid, iso-octyl succinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylene carboxypropane, 1,2,4-cyclohexanetricarboxylic acid, tetra(methylenecarboxyl)methane, 1,2,7,8-octanete tracarboxylic acid, pyromellitic acid, EMPOL trimer acid, cyclohexane dicarboxylic acid, cyclohexene dicarboxylic acid, butane tetracarboxylic acid, diphenylsulfone tetracarboxylic acid, and ethylene glycol bis(trimellitic acid). These may be used alone or in combination.

### ——Modified Polyester Resin——

The modified polyester resin is appropriately selected depending on the intended purpose without any limitation, and examples thereof include a resin obtained through an elongation reaction and/or crosslink reaction of an active hydrogen group-containing compound with polyester reactive with the active hydrogen group-containing compound (may be referred to as “polyester prepolymer hereinafter). The elongation reaction and/or crosslink reaction may be terminated with a reaction terminator (e.g., diethyl amine, dibutyl amine, butyl amine, lauryl amine, and a compound obtained by blocking monoamine, such as a ketimine compound), as needed.

### ———Active Hydrogen Group-Containing Compound———

The active hydrogen group-containing compound functions as an elongation agent or crosslink agent during an elongation reaction or crosslink reaction of the polyester prepolymer in an aqueous medium.

The active hydrogen group-containing compound is appropriately selected depending on the intended purpose without any limitation, provided that it is a compound containing an active hydrogen group. In the case where the polyester prepolymer is an isocyanate group-containing polyester prepolymer described below, the active hydrogen group-containing compound is preferably amine because it can yield a modified polyester resin of high molecular weight.

The active hydrogen group is appropriately selected depending on the intended purpose without any limitation, and examples thereof include a hydroxyl group (alcoholic hydroxyl group or phenolic hydroxyl group), an amino group, a carboxyl group, and a mercapto group. These may be included as per se or a mixture.

The amine serving as the active hydrogen group-containing compound is appropriately selected depending on the intended purpose without any limitation, and examples thereof include diamine, trivalent or higher polyamine, amino alcohol, amino mercaptan, amino acid, and a compound in which an amino group of any of the aforementioned amines is blocked. Examples of the diamine include aromatic diamine (e.g., phenylene diamine, diethyltoluene diamine, and 4,4′-diaminodiphenyl methane); alicyclic diamine (e.g., 4,4′-diamino-3,3′-dimethyldicyclohexyl methane, diamine cyclohexane, and isophorone diamine); and aliphatic diamine (e.g., ethylene diamine, tetramethylene diamine, and hexamethylene diamine). Examples of the trivalent or higher polyamine include diethylene triamine, and triethylene tetramine. Examples of the amino alcohol include ethanol amine, and hydroxyethyl aniline. Examples of the amino mercaptan include aminoethyl mercaptan, and aminopropyl mercaptan. Examples of the amino acid include aminopropionic acid, and aminocaproic acid. Examples of the compound in which an amino group of these amines is blocked include a ketimine compound and oxazoline compound, which are obtained from any of these amines (e.g., the diamine, the trivalent or higher polyamine, the amino alcohol, the amino mercaptan, and the amino acid) and ketones (e.g., acetone, methyl ethyl ketone, and methyl isobutyl ketone). These may be used alone or in combination. Among them, particularly preferred as the amines are diamine, and a mixture of diamine and a small amount of trivalent or higher polyamine.

———Polymer Reactive with Active Hydrogen Group-Containing Compound———

The polymer reactive with the active hydrogen group-containing compound is appropriately selected depending on the intended purpose without any limitation, provided that it is a polymer containing at least a group reactive with the active hydrogen group-containing compound. The polymer reactive with the active hydrogen group-containing compound is preferably a urea bond generating group-containing polyester resin (RMPE), more preferably an isocyanate group-containing polyester prepolymer, because of high fluidity during melting, excellent transparency, easy adjustment of a molecular weight of a high molecular weight component, excellent oil-less low temperature fixing ability and releasing property of a resulting dry toner.

The isocyanate group-containing polyester prepolymer is appropriately selected depending on the intended purpose without any limitation, and examples thereof include a polycondensate prepared from polyol and polycarboxylic acid, and a prepolymer prepared through a reaction between an active hydrogen group-containing polyester resin and polyisocyanate.

The polyol is appropriately selected depending on the intended purpose without any limitation, and examples thereof include: diol, such as alkylene glycol (e.g., ethylene glycol, 1,2-propylene glycol, 1,3-propylene glycol, 1,4-butanediol, and 1,6-hexanediol), alkylene ether glycol (e.g., diethylene glycol, triethylene glycol, dipropylene glycol, polyethylene glycol, polypropylene glycol, and polytetramethylene ether glycol), alicyclic diol (e.g., 1,4-cyclohexane dimethanol, and hydrogenated bisphenol A), bisphenol (e.g., bisphenol A, bisphenol F, and bisphenol S), an alkylene oxide (e.g., ethylene oxide, propylene oxide, and butylene oxide) adduct of the alicyclic diol, an alkylene oxide (e.g., ethylene oxide, propylene oxide, and butylene oxide) adduct of the bisphenol; trihydric or higher polyol, such as polyhydric aliphatic alcohol (e.g., glycerin, trimethylol ethane, trimethylol propane, pentaerythritol, and sorbitol), trihydric or higher phenol (e.g., phenol novolak, and cresol novolak), and an alkylene oxide adduct of the trihydric or higher polyphenol; and a mixture of diol and trihydric or higher polyol. These may be used alone, or in combination. Among them, preferred are the diol alone, or a mixture of the diol and a small amount of the trihydric or higher polyol. The diol is preferably C2-C12 alkylene glycol, and an alkylene oxide adduct of bisphenol (e.g., a bisphenol A ethylene oxide (2 mol) adduct, a bisphenol A propylene oxide (2 mol) adduct, and a bisphenol A propylene oxide (3 mol) adduct).

An amount of the polyol in the isocyanate group-containing polyester prepolymer is appropriately selected depending on the intended purpose without any limitation. For example, it is preferably 0.5% by mass to 40% by mass, more preferably 1% by mass to 30% by mass, and even more preferably 2% by mass to 20% by mass. When the amount thereof is smaller than 0.5% by mass, a resulting toner may have insufficient hot offset resistance, and therefore it may be difficult to achieve both storage stability and low temperature fixing ability of the toner. When the amount thereof is greater than 40% by mass, a resulting toner may have insufficient low temperature fixing ability.

The polycarboxylic acid is appropriately selected depending on the intended purpose without any limitation, and examples thereof include: alkylene dicarboxylic acid (e.g., succinic acid, adipic acid, and sebacic acid); alkenylene dicarboxylic acid (e.g., maleic acid, and fumaric acid); aromatic dicarboxylic acid (e.g., terephthalic acid, isophthalic acid, and naphthalene dicarboxylic acid); trivalent or higher polycarboxylic acid (e.g., C9-C20 aromatic polycarboxylic acid, such as trimellitic acid, and pyromellitic acid). These may be used alone or in combination. Among them, the polycarboxylic acid is preferably C4-C20 alkenylene dicarboxylic acid, and C8-C20 aromatic dicarboxylic acid. Note that, instead of the polycarboxylic acid, anhydride or lower alkyl ester (e.g., methyl ester, ethyl ester, and isopropyl ester) of the polycarboxylic acid may be used.

A blending ratio of the polyol and the polycarboxylic acid is appropriately selected depending on the intended purpose without any limitation, but it is determined as an equivalent ratio [OH]/[COOH] of hydroxyl groups [OH] of the polyol to carboxyl groups [COOH] of the polycarboxylic acid, which is preferably 2/1 to 1/1, more preferably 1.5/1 to 1/1, and even more preferably 1.3/1 to 1.02/1.

The polyisocyanate is appropriately selected depending on the intended purpose without any limitation, and examples thereof include: aliphatic polyisocyanate (e.g., tetramethylene diisocyanate, hexamethylene diisocyanate, 2,6-diisocyanato methyl caproate, octamethylene diisocyanate, decamethylene diisocyanate, dodecamethylene diisocyanate, tetradecamethylene diisocyanate, trimethylhexane diisocyanate, and tetramethylhexane diisocyanate); alicyclic polyisocyanate (e.g., isophorone diisocyanate, and cyclohexylmethane diisocyanate); aromatic diisocyanate (e.g., tolylene diisocyanate, diphenyl methane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate, and diphenylether-4,4′-diisocyanate); aromatic aliphatic diisocyanate (e.g., α,α,α′,α′-tetramethylxylene diisocyanate); isocyanurate (e.g., tris(isocyanatoalkyl)isocyanurate, and tris(isocyanatocycloalkyl)isocyanurate); phenol derivatives thereof; and a block product thereof where the foregoing compounds are blocked with a phenol derivative, oxime, or caprolactam. These may be used alone, or in combination.

A blending ratio of the polyisocyanate and the active hydrogen group-containing polyester resin (hydroxyl group-containing polyester resin) is appropriately selected depending on the intended purpose without any limitation, but it is determined as an equivalent ratio [NCO]/[OH] of isocyanate groups [NCO] of the polyisocyanate to hydroxyl groups [OH] of the hydroxyl group-containing polyester resin, which is preferably 5/1 to 1/1, more preferably 4/1 to 1.2/1, and even more preferably 3/1 to 1.5/1. When the equivalent ratio [NCO]/[OH] is less than 1/1, a resulting toner may have insufficient offset resistance. When the equivalent ratio [NCO]/[OH] is more than 5/1, a resulting toner may have insufficient low temperature fixing ability.

An amount of the polyisocyanate in the isocyanate-group polyester prepolymer is appropriately selected depending on the intended purpose without any limitation, but it is preferably 0.5% by mass to 40% by mass, more preferably 1% by mass to 30% by mass, and even more preferably 2% by mass to 20% by mass. When the amount thereof is smaller than 0.5% by mass, a resulting toner may have insufficient offset resistance, and therefore it may be difficult to achieve both storage stability and low temperature fixing ability of the toner. When the amount thereof is greater than 40% by mass, a resulting toner may have insufficient low temperature fixing ability.

The average number of isocyanate groups contained in one molecule of the isocyanate group-containing polyester prepolymer is preferably 1 or more, more preferably 1.2 to 5, and even more preferably 1.5 to 4. When the average number is less than 1, a molecular weight of the polyester resin modified with a urea bond generating group (RMPE) becomes small, which may adversely affect hot offset resistance of a resulting toner.

A blending ratio of the isocyanate group-containing polyester prepolymer and the amine is appropriately selected depending on the intended purpose without any limitation, but it is determined as a mixing equivalent ratio [NCO]/[NHx] of the isocyanate groups [NCO] in the isocyanate group-containing polyester prepolymer to the amino groups [NHx] in the amine, which is preferably 1/3 to 3/1, more preferably 1/2 to 2/1, and even more preferably 1/1.5 to 1.5/1. When the mixing equivalent ([NCO]/[NHx]) is less than 1/3, low temperature fixing ability of a resulting toner may be impaired. When the mixing equivalent ([NCO]/[NHx]) is more than 3/1, a molecular weight of the urea-modified polyester resin becomes small, which may adversely affect offset resistance of a resulting toner.

———Synthesis Method of Polymer Reactive with Active Hydrogen Group-Containing Compound———

A synthesis method of the polymer reactive with the active hydrogen group-containing compound is appropriately selected depending on the intended purpose without any limitation. In the case of the isocyanate group-containing polyester prepolymer, examples of the synthesis method include a method, which contains heating the polyol and the polycarboxylic acid to 150° C. to 280° C. under the presence of a conventional esterification catalyst (e.g., titanium butoxide, and dibutyl tin oxide) to generate a reaction product optionally with appropriately reducing the pressure, removing water from the reaction system to obtain hydroxyl group-containing polyester, followed by reacting the hydroxyl group-containing polyester with the polyisocyanate at 40° C. to 140° C. to thereby synthesize the isocyanate group-containing polyester prepolymer.

The weight average molecular weight (Mw) of the active hydrogen group-containing compound is appropriately selected depending on the intended purpose without any limitation, but it is preferably 3,000 to 40,000, more preferably 4,000 to 30,000, as in a molecular weight distribution measured by gel permeation chromatography (GPC) of a tetrahydrofuran (THF) soluble component thereof. When the weight average molecular weight (Mw) is smaller than 3,000, storage stability of a resulting toner may be poor. When the weight average molecular weight (Mw) thereof is greater than 40,000, low temperature fixing ability of a resulting toner may be poor. The weight average molecular weight (Mw) can be measured, for example, in the following manner. First, a column is stabilized in a heat chamber of 40° C. At this temperature, tetrahydrofuran (THF) as a column solvent is flown into the column at the flow rate of 1 mL/min, 50 μL to 200 μL of a tetrahydrofuran resin sample solution whose sample concentration is adjusted to 0.05% by mass to 0.6% by mass is injected to carry out a measurement. As for the measurement of the molecular weight of the sample, the molecular weight distribution of the sample is calculated from the relationship with a logarithmic value and count number of a calibration curve formed by a plurality of monodisperse polystyrene standard samples. As for standard polystyrene samples for forming a calibration curve, standard polystyrene samples (of Pressure Chemical Co., or Tosoh Corporation) having molecular weights of 6×10², 2.1×10², 4×10², 1.75×10⁴, 1.1×10⁵, 3.9×10⁵, 8.6×10⁵, 2×10⁶, and 4.48×10⁶ are used. it is preferred that at least 10 standard polystyrene samples be used. Note that, as for a detector, an RI (refractive index) detector can be used.

### <<Releasing Agent>>

The releasing agent is appropriately selected depending on the intended purpose without any limitation, and examples thereof include natural wax, such as vegetable wax (e.g. carnauba wax, cotton wax, Japan wax, and rice wax), animal wax (e.g., bees wax and lanolin), mineral wax (e.g., ozokelite and ceresin), and petroleum wax (e.g., paraffin wax, microcrystalline wax and petrolatum). Examples of the wax other than the natural wax listed above include: synthetic hydrocarbon wax (e.g., Fischer-Tropsch wax, polyethylene wax and polypropylene wax); and synthetic wax (e.g., ester wax, ketone wax and ether wax). Further examples include: a fatty acid amide compound, such as 1,2-hydroxystearic acid amide, stearic amide, phthalic anhydride imide and chlorinated hydrocarbons; low-molecular-weight crystalline polymer resins such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain. Among them, preferred is wax having a melting point of 50° C. to 120° C., because such wax can effectively function as a releasing agent at an interface between a fixing roller and a toner, and therefore hot offset resistance can be improved without applying a releasing agent, such as an oil, to the fixing roller.

The melting point of the releasing agent is appropriately selected depending on the intended purpose without any limitation, but it is preferably 50° C. to 120° C., more preferably 60° C. to 90° C. When the melting point is lower than 50° C., the wax may adversely affect the storage stability of a resulting toner. When the melting point thereof is higher than 120° C., cold offset tends to occur during fixing performed at low temperature. Note that, the melting point of the releasing agent can be determined by measuring the maximum endothermic peak using a differential scanning calorimeter (TG-DSC System, TAS-100, manufactured by Rigaku Corporation).

The melt viscosity of the releasing agent is appropriately selected depending on the intended purpose without any limitation, but when it is measured at the temperature higher than the melting point of the wax by 20° C., the melt viscosity thereof is preferably 5 cps to 1,000 cps, more preferably 10 cps to 100 cps. When the melt viscosity is lower than 5 cps, releasing property may be low. When the melt viscosity is greater than 1,000 cps, the releasing agent cannot be exhibit an effect of improving hot offset resistance and low temperature fixing ability.

An amount of the releasing agent is appropriately selected depending on the intended purpose without any limitation, but it is preferably 40% by mass or less, more preferably 3% by mass to 30% by mass. When the amount thereof is greater than 40% by mass, flowability of the toner may be impaired.

The releasing agent is preferably present in the dispersed state in the toner base particle. To achieve this dispersed state of the releasing agent in the toner base particle, the releasing agent and the binder resin are preferably not compatible to each other. A method for finely dispersing the releasing agent in the toner base particle is appropriately selected depending on the intended purpose without any limitation, and examples thereof include a method containing applying shear force during kneading in the course of the toner production to thereby disperse the releasing agent.

The dispersed state of the releasing agent can be confirmed by observing a thin film cut piece of the toner particle under a transmission electron microscope (TEM). The smaller dispersed diameter of the releasing agent is more preferable. When the dispersed diameter of the releasing agent is too small, however, bleeding of the releasing agent may be insufficient. If the releasing agent can be confirmed with the magnification of ×10,000, it can be said that the releasing agent is present in the dispersed state. When the releasing agent cannot be confirmed with the magnification of ×10,000, bleeding of the releasing agent becomes insufficient during fixing even through the releasing agent is very finely dispersed.

### <Other Components>

Other components are appropriately selected depending on the intended purpose without any limitation, and examples thereof include a colorant, a layered inorganic mineral, a magnetic material, a cleaning improving agent, a flow improving agent, and a charge controlling agent.

### —Colorant—

The colorant is appropriately selected from dyes and pigments known in the art depending on the intended purpose without any limitation, and examples thereof include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used alone or in combination.

An amount of the colorant in the toner is appropriately selected depending on the intended purpose without any limitation, but it is preferably 1% by mass to 15% by mass, more preferably 3% by mass to 10% by mass. When the amount thereof is smaller than 1% by mass, the tinting power of the resulting toner may be weak. When the amount thereof is greater than 15% by mass, problems, such as dispersion failure of the pigment in the toner, low tinting power, and low electric properties of the toner, may be caused.

The colorant may be used as a master batch in which the colorant forms a composite with a resin. The resin is appropriately selected depending on the intended purpose without any limitation, and examples thereof include: a polyester resin; polymer of styrene or substitution thereof (e.g., polystyrene, poly-p-chlorostyrene, and polyvinyl); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer); and others, such as polymethyl methacrylate, polybutyl methacrylate, a polyvinyl chloride resin, a polyvinyl acetate resin, a polyethylene resin, a polypropylene resin, an epoxy resin, an epoxy polyol resin, a polyurethane resin, a polyamide resin, a polyvinyl butyral resin, a polyacryl resin, rosin, modified rosin, a terpene resin, an aliphatic hydrocarbon resin, an alicyclic hydrocarbon resin, an aromatic petroleum resin, chlorinated paraffin, and paraffin wax. These may be used alone or in combination.

A production method of the master batch is appropriately selected depending on the intended purpose without any limitation, and examples thereof include a method containing mixing and/or kneading the resin for the master batch, the colorant, and an organic solvent at high shear force to produce a master batch. Note that, the organic solvent is added to enhance the interaction between the colorant and the binder resin. Moreover, another production method of the master batch is appropriately selected depending on the intended purpose without any limitation, but it is preferably a hashing method in which an aqueous paste containing a colorant is mixed and kneaded with a resin and an organic solvent, and then the colorant is transferred to the resin to remove the water and the organic solvent. This method is preferably used because a wet cake of the colorant is used as it is, and it is not necessary to dry the wet cake of the colorant to prepare a colorant. In the mixing and kneading of the colorant and the resin, a high-shearing disperser (e.g., a three-roll mill) is preferably used.

### —Layered Inorganic Mineral—

The layered inorganic mineral is appropriately selected depending on the intended purpose without any limitation, provided that it is a mineral in which layers each having a thickness of several nanometers are laminated, and examples thereof include montmorillonite, bentonite, hectorite, attapulgite, sepiolite, and a mixture thereof. These may be used alone or in combination. Among them, a modified layered mineral is preferable as it can be deformed during granulation of a toner, exhibit a function of controlling charge, and is excellent in low temperature fixing ability, a modified layered inorganic mineral in which a layered inorganic mineral having a montmorillonite basic crystal structure is modified with organic cations, and an organic modified montmorillonite and bentonite are preferable as they can easily adjust the viscosity without adversely affecting the properties of a toner.

The modified layered inorganic compound is preferably obtained by modifying at least part of the layered inorganic mineral with organic ions. By modifying at least part of the layered inorganic mineral with organic ions, a resulting modified layered inorganic compound has appropriate hydrophobic property, and give an oil phase, which contains a toner composition and/or a toner composition precursor, non-Newtonian viscosity to deform toner particles.

An amount of the modified layered inorganic mineral contained in the toner base particles is appropriately selected depending on the intended purpose without any limitation, but it is preferably 0.05% by mass to 5% by mass.

### —Magnetic Material—

The magnetic material is appropriately selected depending on the intended purpose without any limitation, and examples thereof include iron powder, magnetite, and ferrite. Among them, a white magnetic material is preferable in terms of a color tone.

### —Cleaning Improving Agent—

The cleaning improving agent is appropriately selected depending on the intended purpose without any limitation, provided that it is an agent to be added to the toner in order to remove the residual developer on a photoconductor or a primary transfer member. Examples thereof include: metal salts of fatty acid such as stearic acid (e.g. zinc stearate, and calcium stearate); and polymer particles produced by soap-free emulsification polymerization, such as polymethyl methacrylate particles, and polystyrene particles. The volume average particle diameter of the polymer particles is appropriately selected depending on the intended purpose without any limitation, but the polymer particles preferably have a relatively narrow particle size distribution, more preferably having the volume average particle diameter of 0.01 μm to 1 μm.

### —Flow Improving Agent—

The flow improving agent is an agent used to perform a surface treatment to improve hydrophobicity so as to prevent the toner from reducing its fluidity and charging properties in high humidity environments. Examples thereof include a silane coupling agent, a sililating agent, a silane coupling agent having a fluoroalkyl group, an organic titanate-based coupling agent, an aluminum-based coupling agent, silicone oil, and modified silicone oil. Silica or titanium oxide is particularly preferably used as hydrophobic silica or hydrophobic titanium oxide, by surface treating the silica or titanium oxide with the aforementioned flow improving agent.

### —Charge Controlling Agent—

The charge controlling agent is appropriately selected depending on the intended purpose without any limitation, and examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based active agents, metal salts of salicylic acid, metal salts of salicylic acid derivatives, copper phthalocyanine, perylene, quinacridon, azo-based pigments, and polymer compound having a functional group (e.g., sulfonic acid group, carboxyl group, and quaternary ammonium salt).

Examples of the trade names of the commercial products usable as the charge controlling agent include: nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (all manufactured by Clariant K.K.); and LRA-901, and LR-147 (both manufactured by Japan Carlit Co., Ltd.).

An amount of the charge controlling agent is appropriately selected depending on the intended purpose without any limitation, but it is preferably 0.1 parts by mass to 10 parts by mass, more preferably 0.2 parts by mass to 5 parts by mass, relative to 100 parts by mass of the binder resin. When the amount thereof is greater than 10 parts by mass, the electrostatic propensity of the resulting toner is excessively large, and therefore an effect of the charge controlling agent is reduced and electrostatic force to a developing roller increases, which may reduce flowability of the toner, or reduce image density of images formed with the resulting toner. The charge controlling agent may be added by dissolving and dispersing after melting and kneading together with the master batch or the resin, or added by dissolving or dispersing directly in the organic solvent, or added by fixing on a surface of each toner particle after the preparation of the toner particles.

### <Production Method of Toner>

The production method of the toner is appropriately selected depending on the intended purpose without any limitation, and examples thereof include a method for producing a toner using a pulverization method, and a method for producing a toner using a polymerization method. Among them, the method for producing a toner using the polymerization method is preferable as a toner of small diameter can be obtained.

The polymerization method is appropriately selected depending on the intended purpose without any limitation, and examples thereof include a suspension polymerization method, a dissolution suspension method, and an emulsification polymerization aggregation method. Among them, a dissolution suspension method is preferable.

The dissolution suspension method is appropriately selected depending on the intended purpose without any limitation, but it preferably contains an oil phase preparation step, an aqueous phase preparation step, an emulsifying or dispersing step, a solvent removing step, a washing and drying step, and an external additive treating step.

A specific example of the dissolution suspension method is appropriately selected depending on the intended purpose without any limitation, but it is preferably a method containing: dissolving or dispersing in an organic solvent at least the binder resin and the colorant to prepare a solution or a dispersion; adding the solution or dispersion to an aqueous phase and emulsifying or dispersing the solution or dispersion in the aqueous phase to prepare an emulsion or a dispersion liquid; removing the organic solvent from the emulsion or dispersion liquid to prepare toner base particles; and mixing the toner base particles with an external additive to produce a toner.

Among the dissolution suspension method, an ester elongation method is preferable. As for a specific example of the ester elongation method, preferred is a method containing: dissolving or dispersing in an organic solvent at least the active hydrogen group-containing compound, the polymer reactive with the active hydrogen group-containing compound, the binder resin, and the colorant to prepare a solution or a dispersion; adding the solution or dispersion to an aqueous phase and emulsifying or dispersing the solution or dispersion in the aqueous phase to prepare an emulsion or a dispersion liquid; allowing the active hydrogen group-containing compound and the polymer reactive with the active hydrogen group-containing compound to carry out an elongation or crosslink reaction in the emulsion or dispersion liquid; removing the organic solvent from the emulsion or dispersion liquid to prepare toner base particles; and mixing the toner base particles with an external additive to produce a toner.

This method can yield a toner having the excellently dispersed releasing agent, and excellent flowability. Such toner can be transported to a developing device without forming a dead space in a developer transporting device.

### <<Oil Phase Preparation Step>>

The oil phase preparation step is dissolving or dispersing in an organic solvent a toner material containing at least the binder resin and the colorant to prepare an oil phase (a solution or dispersion of the toner material). The organic solvent is appropriately selected depending on the intended purpose without any limitation, but it is preferably an organic solvent having a boiling point of lower than 150° C. in view of easiness of removal thereof. The organic solvent having a boiling point of lower than 150° C. is appropriately selected depending on the intended purpose without any limitation, and examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone or in combination. Among them, preferred are ethyl acetate, toluene, xylene, benzene, methylene chloride, 1,2-dichloroethane, chloroform, and carbon tetrachloride, and particularly preferred is ethyl acetate.

### <<Aqueous Phase Preparation Step>>

The aqueous phase preparation step is preparing an aqueous phase (aqueous medium). The aqueous phase is appropriately selected depending on the intended purpose without any limitation, and examples thereof include water, a solvent miscible with water, and a mixture thereof. These may be used alone or in combination. Among them, water is preferable. Examples of the solvent miscible with water include alcohol (e.g., methanol, isopropanol, and ethylene glycol), dimethyl formamide, tetrahydrofuran, cellosolve (e.g., Methyl Cellosolve®), and lower ketone (e.g., acetone, and methyl ethyl ketone).

### <<Emulsifying or Dispersing Step>>

The emulsifying or dispersing step is dispersing the oil phase in the aqueous phase to prepare an emulsion or a dispersion liquid. The materials for the toner material are not necessarily mixed at the time when particles are formed in an aqueous phase, and the materials may be added after forming particles. For example, after forming particles each of which does not contain the colorant, the colorant can be added by a conventional dyeing method. An amount of the aqueous phase used relative to 100 parts by mass of the toner material is appropriately selected depending on the intended purpose without any limitation, but it is preferably 100 parts by mass to 1,000 parts by mass. When the amount thereof is less than 100 parts by mass, a dispersed state of the toner material may not be desirable and therefore toner particles of the predetermined particle size may not be obtained. When the amount thereof is greater than 1,000 parts by mass, it may be economically undesirable. Moreover, a dispersant may be used, as needed. Use of the dispersant is preferable as it can achieve a sharp particle size distribution, and stabilize a dispersion state.

The dispersant used in the emulsifying or dispersing step is appropriately selected depending on the intended purpose without any limitation, and examples thereof include an anionic surfactant, a cationic surfactant, a nonionic surfactant, an amphoteric surfactant, an anionic surfactant having a fluoroalkyl group, a cationic surfactant having a fluoroalkyl group, an inorganic compound (e.g., tricalcium phosphate, calcium carbonate, titanium oxide, colloidal silica, and hydroxyapattite), and polymer particles (e.g., MMA polymer particles (1 μm), MMA polymer particles (3 μm), styrene particles (0.5 μm), styrene particles (2 μm), and syrene-acrylonitrile polymer particles (1 μm)). Among them, a surfactant having a fluoroalkyl group is preferable because it can exhibit an effect with a small amount thereof.

Examples of a commercial name of the dispersant include: SURFLON S-111, S-112, S-113, S-121 (all manufactured by Asahi Glass Co., Ltd.); FLUORAD FC-93, FC-95, FC-98, FC-129, FC-135 (all manufactured by Sumitomo 3M Limited); UNIDYNE DS-101, DS-102, DS-202 (all manufactured by DAIKIN INDUSTRIES, LTD.); MEGAFAC F-110, F-120, F-113, F-150, F-191, F-812, F-824, F-833 (all manufactured by DIC Corporation); EFTOP EF-102, 103, 104, 105, 112, 123A, 123B, 132, 306A, 501, 201, 204, (all manufactured by Mitsubishi Materials Electronic Chemicals Co., Ltd.); FUTARGENT F-100, F-300, F150 (all manufactured by NEOS COMPANY LIMITED); SGP, SGP-3G (both manufactured by Soken Chemical & Engineering Co., Ltd.); PB-200H (manufactured by Kao Corporation); Techno Polymer SB (manufactured by Sekisui Chemical Co., Ltd.); and Micropearl (manufactured by Sekisui Chemical Co., Ltd.).

When the dispersant is used, the dispersant may be left on surfaces of the toner particles, but the dispersant is preferably washed and removed from the toner particles after the reaction in view of charging properties of the toner. Further, a solvent capable of dissolving the modified polyester after the reaction of the polyester prepolymer is preferably used to give a sharp particle size distribution and lower the viscosity of the toner material. The solvent is preferably a volatile solvent having a boiling point of lower than 100° C. in view of easiness of removal thereof, and examples of such solvent include: a solvent miscible with water, such as toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, tetrahydrofuran, and methanol. These may be used alone or in combination. Among them, preferred are an aromatic solvent such as toluene, and xylene, and a halogenated hydrocarbon such as methylene chloride, 1,2-dichloroethane, chloroform, and carbon tetrachloride. An amount of the solvent is appropriately selected depending on the intended purpose without any limitation, but it is preferably 0 parts by mass to 300 parts by mass, more preferably 0 parts by mass to 100 parts by mass, and even more preferably 25 parts by mass to 70 parts by mass, relative to 100 parts by mass of the polyester prepolymer. In the case where the solvent is used, after completing the elongation and/or crosslink reaction, the solvent is removed by heating under atmospheric pressure or reduced pressure.

In the case where the dispersant is used, a dispersion stabilizer is preferably used in combination. The dispersion stabilizer is appropriately selected depending on the intended purpose without any limitation, provided that it is a material stabilizing dispersed droplets with a polymer protective colloid, or water-insoluble organic particles. Examples thereof include: acid such as acrylic acid, methacrylic acid, α-cyanoacrylic acid, α-cyanomethacrylic acid, itaconic acid, crotonic acid, fumaric acid, maleic acid, and maleic anhydride; a (meth)acrylic monomer having a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acryl amide, and N-methylol methacryl amide; vinyl alcohol and ethers thereof (e.g., vinyl methyl ether, vinyl ethyl ether, and vinyl propyl ether); ester of vinyl alcohol (e.g., vinyl acetate, vinyl propionate, and vinyl butyrate) with a compound having a carboxyl group; a stabilizer, such as acryl amide, methacryl amide, diacetone acryl amide, and a methylol compound thereof; acid chloride, such as acrylic acid chloride, and methacrylic acid chloride; a homopolymer or copolymer of a compound having a nitrogen atom or heterocycle thereof, such as vinyl pyridine, vinyl pyrrolidone, vinyl imidazole, and ethylene imine; a polyoxyethylene-based stabilizer, such as polyoxyethylene, polyoxypropylene, polyoxyethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, and polyoxyethylene nonylphenyl ester; and cellulose, such as methyl cellulose, hydroxyethyl cellulose, and hydroxypropyl cellulose.

When a compound soluble to both acid and alkali, such as calcium phosphate, is used as the dispersion stabilizer, calcium phosphate is preferably removed from the particles by dissolving calcium phosphate with acid, such as hydrochloric acid, followed by washing with water. Note that, the removal of calcium phosphate may also be performed by decomposing with enzyme.

A disperser used in the emulsifying or dispersing step is appropriately selected depending on the intended purpose without any limitation, and examples thereof include a low speed shearing disperser, a high speed shearing disperser, a friction disperser, a high pressure jet disperser, and an ultrasonic wave disperser. Among them, the high speed shearing disperser is preferable because it is capable of controlling particle diameters of dispersed elements (oil droplets) to 2 μm to 20 μm. In the case where the high speed shearing disperser is used, the conditions, such as the rotation number, dispersing time, and dispersing temperature, are appropriately selected depending on the intended purpose. The rotation number is appropriately selected depending on the intended purpose without any limitation, but it is preferably 1,000 rpm to 30,000 rpm, more preferably 5,000 rpm to 20,000 rpm. The dispersion time is appropriately selected depending on the intended purpose without any limitation, but it is preferably 0.1 minutes to 5 minutes in the case of the batch system. The dispersing temperature is appropriately selected depending on the intended purpose without any limitation, but it is preferably 0° C. to 150° C., more preferably 40° C. to 98° C., under the pressure. Note that, generally, higher the dispersing temperature is, easier the dispersing is.

### <<Solvent Removing Step>>

The solvent removing step is removing the organic solvent from the emulsion or dispersion liquid (e.g., a dispersion liquid, such an emulsified slurry). A method for removing the organic solvent is appropriately selected depending on the intended purpose without any limitation, and examples thereof include: a method where a temperature of an entire system is gradually increased to evaporate the organic solvent contained in the oil droplets; and a method where the dispersion liquid is sprayed (by a spray dryer, belt dryer, rotary kiln, or the like) in a dry atmosphere (e.g., heated gas, such as air, nitrogen, carbon dioxide, and combustion gas) to remove the organic solvent in the oil droplets. Using any of these method, the intended quality can be sufficiently achieved within a short processing time. Once the organic solvent is removed, toner base particles are formed.

### <<Washing and Drying Step>>

The washing and drying step is washing and drying the toner base particles. The toner base particles may be further subjected to classification. The classifying can be performed by removing the fine particles component by means of a cyclone, a decanter, a centrifugal separator, or the like. Alternatively, the classification can be performed after drying the toner base particles. Note that, the undesirable fine particles or coarse particles obtained from the classification may be used again for formation of particles. In this case, the fine particles or coarse particles may be in the wet state.

### <<External Additive Treating Step>>

The external additive treating step is mixing and treating the dried toner base particles with the external additive that satisfies the parameter specified in the present invention. Once the toner base particles are mixed with the external additive, the toner of the present invention is obtained. A device used for the mixing is appropriately selected depending on the intended purpose without any limitation, but it is preferably HENSCHEL MIXER (manufactured by Nippon Cole & Engineering Co., Ltd.). In order to prevent the external additive from falling off from the surfaces of the toner base particles, a mechanical impact may be applied. A method for applying the mechanical impact is appropriately selected depending on the intended purpose without any limitation, and examples thereof include: a method containing applying an impact to a mixture with a high-speed rotating blade; and a method containing placing a mixture in a high-speed air flow, accelerating the air speed so that the particle collide against one another or that particles are crashed into an appropriate collision plate to thereby apply an impact. A device used in such method is appropriately selected depending on the intended purpose without any limitation. Examples thereof include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a krypton system (product of Kawasaki Heavy Industries, Ltd.) and an automatic mortar.

### <Properties of Toner>

A ratio (Dv/Dn) of the volume average particle diameter (Dv) to number average particle diameter (Dn) of the toner is appropriately selected depending on the intended purpose without any limitation, but it is preferably 1.30 or less, more preferably 1.00 to 1.30. When the ratio (Dv/Dn) is less than 1.00, in case of a two-component developer, the toner is fused on the surfaces of carrier particles after being stirred for a long period in a developing device, which may lead to low charging ability of the carrier, or poor cleaning ability. In case of a one-component developer, toner filming to a developing roller, or a toner fusion to a member, such as a blade for reducing a thickness of a toner layer, tends to occur. When the ratio (Dv/Dn) is more than 1.30, it is difficult to form an image having high resolution and high image quality, and particle diameters of the toner particles may significantly change after the toner is supplied to the developer to compensate the spent toner. On the other hand, when the ratio (Dv/Dn) is within the aforementioned more preferable range, it is advantageous because excellent storage stability, low temperature fixing ability, and hot offset resistance can be achieved. Especially, when such toner is used for a full-color photocopier, glossiness of an image is excellent. In the case of a two-component developer, diameters of the toner particles in the two-component developer do not change largely even when the toner is supplied to the developer to compensate the spent toner, and the toner can achieve excellent and stable developing ability even when the toner is stirred in a developing device for a long period. In the case of a one-component developer, diameters of the toner particles in the two-component developer do not change largely even when the toner is supplied to the developer to compensate the spent toner, the toner does not cause filming to a developing roller, nor fuse to a layer thickness regulating member such as a blade for thinning a thickness of a layer of the toner, and provides excellent and stable developing ability and image even when it is stirred in the developing unit over a long period of time, and therefore it is possible to provide a high quality image.

The volume average particle diameter (Dv) of the toner is appropriately selected depending on the intended purpose without any limitation, but it is preferably 2 μm to 8 μm, more preferably 3 μm to 7 μm. When the Dv thereof is smaller than 2 μm, cleaning property of the toner may be impaired. When the Dv thereof is greater than 8 μm, a fine line reproducibility may be significantly impaired. On the other hand, when the Dv is within the aforementioned preferable range, it is advantageous because both fine line reproducibility and cleaning property can be achieved.

The volume average particle diameter (Dv) and number average particle diameter (Dn) of the toner can be measured by means of a particle size analyzer (Multisizer III, manufactured by Bechman Coulter, Inc.) with an aperture size of 100 μm, and using an analysis software (Beckman Coulter Multisizer 3 Version 3.51). Specifically, a 100 mL glass beaker is charged with 0.5 mL of a 10% by mass surfactant (alkyl benzene sulfonate, Neogen SC-A, manufactured by Dai-Ichi Kogyo Seiyaku Co., Ltd.), followed by adding 0.5 g of each toner. The resulting mixture was stirred with a microspatula. To the mixture, 80 mL of ion-exchanged water is added, and a resulting dispersion liquid is dispersed for 10 minutes by means of a ultrasonic wave disperser (W-113MK-II, manufactured by Honda Electronics Co., Ltd.). This dispersion liquid is subjected to a measurement using the particle size analyzer and a solution for measurement (ISOTON III, Bechman Coulter, Inc.). The measurement is performed by adding the toner sample dropwise in a manner that the concentration indicated by the device is in the range of 8%±2%. It is important for this measuring method that the concentration is kept in the range of 8%±2% in view of the measuring reproducibility of the particle diameter. As long as the concentration is within the aforementioned range, an error in the measurement of the particle diameter is not caused.

The average circularity of the toner is appropriately selected depending on the intended purpose without any limitation. To reduce adhesion between the toner particles, and improve low flowability of the initial toner by applying a sufficient force between the toner particles to separate the toner particles, the average circularity preferably satisfy: 1.00≦(1−B)/(1−A)≦4.00, more preferably 1.25≦(1−B)/(1−A)≦3.00, and even more preferably 1.40≦(1−B)/(1−A)≦2.50, where A is the average circularity of the particles in the range of 0.7 μm to (Dn/2) μm, and B is the average circularity of the particles in the range of 0.7 μm to (Dn×2) μm. The circularity is defined as follows:

The circularity SR=(boundary length of a circle having the same area to that of a projected area of a particle/boundary length of a projected image of a particle)

As the shape of the toner particle is closer to a sphere, the value is closer to 1.00.

The average circularity of the toner is appropriately selected depending on the intended purpose without any limitation, but it is preferably 0.95 to 0.98. When the average circularity is less than 0.95, uniformity in an image is impaired during developing, transfer property of the toner from an electrophotographic photoconductor to an intermediate transfer member, or from the intermediate transfer member to a recording medium is impaired so that uniform transfer may not be performed. When the average circularity is within the aforementioned preferable range, on the other hand, it is advantageous because downsizing of the toner particles can be achieved particularly with a color toner, and excellent transfer property of the toner can be achieved.

The measurement of the average circularity is performed by means of a flow particle image analyzer (FPIA-2000, manufactured by Sysmex Corporation). Specifically, a predetermined container is charged with 100 mL to 150 mL of water, from which impurity solids have been removed in advance, followed by adding as a dispersant, 0.1 mL to 0.5 mL of a surfactant, and adding 0.1 g to 935 g of a measuring sample. A resulting suspension liquid, in which the sample is dispersed, is dispersed for about 1 minute to about 3 minutes by means of a ultrasonic wave disperser, and the resulting dispersion liquid having a concentration of 3,000 particles/μL to 10,000 particles/μL is subjected to measurement of shape and distribution of the toner.

### (Developer)

The developer of the present invention contains at least the toner of the present invention, and may further contain other components, if necessary. The developer may be a one-component developer or two-component developer. Note that, in the case where the developer is a two-component developer, the toner of the present invention and a carrier are mixed to be used as the developer. In the case where the developer is a one-component developer, the toner of the present invention is used as a one-component magnetic or non-magnetic toner.

The developer is preferably a two-component developer containing at least the toner of the present invention and the carrier.

### <Carrier>

The carrier contains magnetic core particles, and a coating resin that coats each core particle, and may further contain electroconductive powder, and a silane coupling agent. Determination of particle diameters of carrier particles and those of the core particles that are a skeleton of the carrier.

A mass ratio of the carrier and the toner contained in the developer is appropriately selected depending on the intended purpose without any limitation, but the developer preferably contains 1 part by mass to 10 parts by mass of the toner relative to 100 parts by mass of the carrier.

### —Core Particles—

The core particles are appropriately selected depending on the intended purpose without any limitation, provided that they are core particles having the magnetic charge of 40 emu/g or more when the magnetic field of 1,000 oersted (Oe) is applied to the carrier. Examples thereof include a ferromagnetic material (e.g., iron, and cobalt), magnetite, hematite, Li-based ferrite, MnZn-based ferrite, CuZn-based ferrite, NiZn-based ferrite, Ba-based ferrite, and Mn-based ferrite. In the case where the crushed particles of the magnetic material is used as core particles (e.g., of ferrite and magnetite), the core particles can be obtained by classifying primary granulated product before firing, firing the classified particle to prepare baked particles, classifying the baked particles to prepare groups of particles having different particle size distributions, and mixing a plurality of the groups of the particles.

A method for classifying the core particles is appropriately selected depending on the intended purpose without any limitation, and for example, a conventional classifying method using a screen classifier, a gravitational classifier, a centrifugal classifier, or an inertial classifier can be used. However, a method using an air classifier (e.g., a gravitational classifier, a centrifugal classifier, and an inertial classifier) is preferable, as excellent productivity can be achieved and a classification point can be easily changed.

### —Coating Resin—

The coating resin is appropriately selected depending on the intended purpose without any limitation, and examples thereof include an amino-based resin, a urea-formaldehyde resin, a melamine resin, a guanamine resin, a urea resin, a polyamine resin, a polyvinyl-based resin, a polyvinylidene-based resin, an acrylic resin, a polymethyl methacrylate resin, polyacrylonitrile resin, a polyvinyl acetate resin, a polyvinyl alcohol resin, a polyvinyl butyral, a polystyrene-based resin (e.g., a polystyrene resin, and a styrene-acryl copolymer resin), a halogenated olefin resin (e.g., polyvinyl chloride), a polyester-based resin (e.g., a polyethylene terephthalate resin, and a polybutylene terephthalate resin), a polycarbonate-based resin, a polyethylene resin, a polyvinyl fluoride resin, a polyvinylidene fluoride resin, a polytrifluoroethylene resin, a polyhexafluoropropylene resin, a copolymer of vinylidene fluoride and an acryl monomer, a copolymer of vinylidene fluoride and vinyl fluoride, a fluoro terpolymer (e.g., a terpolymer of tetrafluoroethylene, vinylidene fluoride, and non-fluoro monomer), a silicone resin, and an epoxy resin. These may be used alone or in combination. Among them, a silicone resin is preferable.

The silicone resin is appropriately selected depending on the intended purpose without any limitation, and examples thereof include a straight silicone resin; and a modified silicone resin, such as epoxy-modified silicone, acryl-modified silicone, phenol-modified silicone, urethane-modified silicone, polyester-modified silicone, and alkyd-modified silicone. Examples of a commercial product of the straight silicone resin include: KR271, KR272, KR282, KR252, KR255, and KR152 (all manufactured by Shin-Etsu Chemical Co., Ltd.); and SR2400, and SR2406 (both manufactured by Dow Corning Toray Co., Ltd.). Examples of a commercial product of the modified silicone resin include: ES-1001N, KR-5208, KR-5203, KR-206, and KR-305 (all manufactured by Shin-Etsu Chemical Co., Ltd.); and SR2115, and SR2110 (both manufactured by Dow Corning Toray Co., Ltd.).

A resin used in combination with the silicone is appropriately selected depending on the intended purpose without any limitation, and examples thereof include: a styrene-based resin, such as polystyrene, chloropolystyrene, poly-α-methyl styrene, a styrene-chlorostyrene copolymer, a styrene-propylene copolymer, a styrene-butadiene copolymer, a styrene-vinyl chloride copolymer, a styrene-vinyl acetate copolymer, a styrene-maleic acid copolymer, a styrene-acrylic acid ester copolymer (e.g., a styrene-methyl acrylate copolymer, a styrene-ethyl acrylate copolymer, a styrene-butyl acrylate copolymer, a styrene-octyl acrylate copolymer, and a styrene-phenyl acrylate copolymer), a styrene-methacrylic ester copolymer (e.g., a styrene-methyl methacrylate copolymer, a styrene-ethyl methacrylate copolymer, a styrene-butyl methacrylate copolymer, and a styrene-phenyl methacrylate copolymer), a styrene-methyl α-chloroacrylate copolymer, and a styrene-acrylonitrile-acrylic acid ester copolymer; an epoxy resin; a polyester resin; a polyethylene resin; a polypropylene resin; an iomer resin; a polyurethane resin; a ketone resin; an ethylene-ethyl acrylate copolymer; a xylene resin; a polyamide resin; a phenol resin; a polycarbonate resin; a melamine resin; and a fluororesin.

A compound suitably used in combination with the silicone resin is appropriately selected depending on the intended purpose without any limitation, but it is preferably an amino silane coupling agent, as a carrier having excellent durability can be obtained. An amount of the amino silane coupling agent contained in the coating layer is appropriately selected depending on the intended purpose without any limitation, but it is preferably 0.001% by mass to 30% by mass.

### —Production Method of Carrier—

A production method of the carrier is appropriately selected depending on the intended purpose without any limitation, and examples thereof include a method containing forming a coating layer on each surface of the core particles to thereby prepare the carrier. A method for forming a coating layer on each surface of the core particles is appropriately selected depending on the intended purpose without any limitation, and examples thereof include spray drying, dip coating, and powder coating. Among them, a method using a fluid bed coating device is preferable as it is effective in formation of a uniform coating layer. A thickness of the coating layer on the surface of the core particle is appropriately selected depending on the intended purpose without any limitation, but it is preferably 0.02 μm to 1 μm, more preferably 0.03 μm to 0.8 μm. Note that, as the thickness of the coating layer is extremely thin, the particle diameter of the carrier in which the coating layer has been formed on each surface of the core particles and the particle diameter of the carrier core particles are substantially the same.

### —Properties of Carrier—

The carrier is appropriately selected depending on the intended purpose without any limitation, but it is preferably a carrier having a sharp particle size distribution, and uniform particle size. It is preferred that the carrier and the carrier core particles whose number average particle diameter (Dp) as well as weight average particle diameter (Dw) are regulated be used.

The weight average particle diameter Dw of the carrier is appropriately selected depending on the intended purpose without any limitation, but it is preferably 15 μm to 40 μm. When the weight average particle diameter Dw thereof is smaller than 15 μm, the carrier is transferred together with the toner in the transferring step, and the carrier deposition tends to occur. When the weight average particle diameter Dw thereof is greater than 40 μm, the carrier deposition does not easily happen, but background smearing tends to occur when the toner density is set high to attain high image density. In the case where a dot diameter of the latent image is small, a variation in the dot reproducibility becomes significant, and therefore granularity in a high light area may be impaired. Note that, the weight average particle diameter (Dw) of the carrier is calculated from the particle size distribution (a relationship between a proportion of numbers of particles and particle diameters) measured on number basis. The weight average particle diameter (Dw) of the carrier can be represented by the following formula (i):

Dw={1/Σ(nD3)}×{Σ(nD4)} Formula (i)

In the formula (1), D is a representing particle diameter (μm) of particles present in each channel, and n is a total number of the particles present in each channel. Note that, the channel means a length for equally dividing the particle diameter range in a particle size distribution diagram, and in the present invention, 2 μm is used as the channel. Moreover, as for the representing particle diameter of the particles present in each channel, the minimum value of the particle diameters of the particles present in each channel is used.

The bulk density of the carrier is appropriately selected depending on the intended purpose without any limitation, but it is preferably 2.15 g/cm³ to 2.70 g/cm³, more preferably 2.25 g/cm³ to 2.60 g/cm³, in view of the influence to a carrier deposition. When the bulk density is less than 2.15 g/cm³, the carrier particles become porous or irregularities in a profile of a surface of a carrier particle increase, and therefore a substantial magnetic value per particle is small even the magnetic charge (emu/g) of the core particle at 1 KOe is large, which is disadvantageous in view of carrier deposition. When the bulk density is made greater than 2.70 g/cm³ by increasing the firing temperature, core particles tend to be fused to each other, and it may be difficult to break down the fused particles. The bulk density is measured in the following manner in accordance with a metal powder-apparent density testing method (JIS-Z-2504). The carrier is naturally flown out from an orifice having a diameter of 2.5 mm to a cylindrical stainless steel container having the volume of 25 cm³, which is placed directly under the orifice until the container is overflowed with the carrier. The carrier at the top of the container is scraped out in once procedure with a non-magnetic horizontal spatula by moving the spatula along the top edge of the container. A mass of the carrier flown into the container is divided with the volume of the container (25 cm³) to determine a mass of the carrier per 1 cm³. The resulting value is determined as a bulk density of the carrier. Note that, in the case where the carrier is difficult to flow out from the aforementioned orifice, an orifice having a diameter of 5 mm is used to naturally flow the carrier therefrom.

The electrical resistivity (logR) of the carrier is appropriately selected depending on the intended purpose without any limitation, but it is preferably 11.0 Ω·cm to 17.0 Ω·cm, more preferably 11.5 Ω·cm to 16.5 Ω·cm. When the electrical resistivity (logR) is lower than 11.0 Ω·cm, in the case that a developing gap (the minimum distance between the photoconductor and the developing sleeve) is narrow, carrier deposition tends to occur as charge is lead to the carrier. When the electrical resistivity is greater than 17.0 Ω·cm, the edge effect is enhanced to reduce the image density in a solid image area, and charge having an opposite polarity to that of the toner tends to accumulated to charge the carrier, so that the carrier deposition tends to occur.

A method for adjusting the electrical resistivity (logR) of the carrier is appropriately selected depending on the intended purpose without any limitation, and examples thereof include a method for adjusting the electrical resistivity of the carrier by adjusting the resistivity of the coating resin on the core particle; a method for adjusting the electrical resistivity of the carrier by adjusting a thickness of the coating layer; and a method for adjusting the resistivity of the coating resin by adding the electroconductive powder to the coating resin layer. The electroconductive powder is appropriately selected depending on the intended purpose without any limitation, and examples thereof include: metal, such as electroconductive ZnO, and Al; metal oxide, such as selenium oxide, alumina, surface-hydrophobing SiO₂, and TiO₂; SnO₂ prepared by various method, and SnO₂ doped with various elements; boride, such as TiB₂, ZnB₂, and MoB₂; silicon carbide; an electroconductive polymer, such as polyacetylene, polyparaphenylene, poly(paraphenylene sulfide)polypyrrol, and polyethylene; and carbon black, such as furnace black, acetylene black, and channel black. The electroconductive powder can be provided to the carrier in the following manner. Specifically, after adding the electroconductive powder to a solvent used for coating or a coating resin solution, the mixture is uniformly dispersed by means of a disperser using a media (e.g., a ball mill, and a bead mill), or a stirrer equipped with a high-speed rotating blade, to thereby prepare a coating layer forming dispersion liquid, and coating core particles with the coating layer forming dispersion liquid, to thereby prepare a carrier. The average particle diameter of the electroconductive powder is appropriately selected depending on the intended purpose without any limitation, but it is preferably 1 μm or smaller in view of easiness of control in electric resistance.

The magnetic charge of the carrier is appropriately selected depending on the intended purpose without any limitation, provided that it is the magnetic charge required for forming a magnetic brush. The magnetic charge of the carrier when a magnetic field of 1,000 oersted (Oe) is applied is preferably 40 emu/g to 100 emu/g, more preferably 50 emu/g to 90 emu/g. When the magnetic charge thereof is less than 40 emu/g, carrier deposition tends to occur. When the magnetic charge thereof is greater than 100 emu/g, trace of the magnetic brush may be left strongly. Note that, the magnetic charge can be measured in the following manner. As a measuring device, a B-H tracer (BHU-60, manufactured by Riken Denshi Co., Ltd.) is used. A cylindrical cell is filled with 1 g of carrier core particles and set in the device. The magnetic field is gradually increased up to 3,000 oersted (Oe), followed by gradually decreased to 0. Thereafter, the magnetic field of the opposite direction is gradually increased to 3,000 oersted (Oe), followed by gradually decreased to 0. Thereafter, the magnetic field of the same direction to that of the initial magnetic field is applied. In this manner, a B-H curve is drawn, and a magnetic moment of 1,000 oersted is calculated from the curve. The magnetic charge of the carrier is fundamentally determined by a magnetic material used as core particles.

### (Process Cartridge)

The process cartridge can be used for the image forming apparatus of the present invention, and contains a latent electrostatic image bearing member (an electrophotographic photoconductor), and a developing unit configured to develop using the toner of the present invention to form a visible image. The process cartridge can be detachably mounted in the image forming apparatus of the present invention.

The process cartridge is specifically explained with reference to FIG. 5. The process cartridge 800 illustrated in FIG. 5 contains a photoconductor 801, a charging unit 802, a developing unit 803, and a cleaning unit 806. The operations of the process cartridge 800 will be explained. The photoconductor 801 is rotationally driven at a certain rim speed, and during the rotation of the photoconductor 801, the peripheral surface of the photoconductor 801 is uniformly charged with the predetermined positive or negative potential by the charging unit 802. Next, imagewise exposure light is applied from an image exposing unit (e.g., slit exposure, and laser beam scanning exposure) to thereby sequentially form a latent electrostatic image on the peripheral surface of the photoconductor 801. The formed latent electrostatic image is turned into a toner image by means of the developing unit 803, and the developed toner image is sequentially transferred to a recording medium fed between the photoconductor 801 and the transfer unit synchronously to the rotation of the photoconductor 801 from the paper feeding section. The recording medium on which the image has been transferred is separated from the surface of the photoconductor and guided to an image forming unit, which is not illustrated in FIG. 5, and then is discharged from the device as a photocopy. The surface of the photoconductor 801 after the image transfer is cleaned by means the cleaning unit 806 by removing the residual toner from the transfer. Further, the surface of the photoconductor 801 is diselectrified, followed by being repeatedly used for image formation.

### (Image Forming Method and Image Forming Apparatus)

The image forming apparatus of the present invention houses the toner or developer of the present invention, and contains at least a latent electrostatic image bearing member (an electrophotographic photoconductor), a latent electrostatic image forming unit, a developing unit, a transfer unit, and a fixing unit, preferably further contains a toner transporting unit, and may further contain other units, if necessary. The image forming apparatus is suitably used as a full-color image forming apparatus, and the toner or developer of the present invention is used in the developing unit. The latent electrostatic image forming unit is a unit combining a charging unit and an exposing unit.

The image forming apparatus is appropriately selected depending on the intended purpose without any limitation, but it is preferably a high-speed image forming apparatus capable of forming an image at speed of 55 sheets/min or faster with the recording medium of A4 size, where the recording medium is fed in the direction along the shorter side of the recording medium. The image forming apparatus is preferably equipped with a controlling unit capable of carrying out such image formation.

The image forming method contains at least a latent electrostatic image forming step, a developing step, a transferring step, and a fixing step, preferably further contains a toner transporting step, and may further contain other steps, as needed. The image forming method is suitably used as a full-color image forming method, and the toner of the present invention is used in the developing step. Note that, the latent electrostatic image forming step is a combination of a charging step and an exposing step.

The full-color image forming apparatus is preferably a tandem image forming apparatus, which contains a plurality of a set consisting of an electrophotographic photoconductor, a charging unit, an exposing unit, a developing unit, a primary transfer unit, and a cleaning unit. The tandem image forming apparatus, which is equipped with a plurality of electrophotographic photoconductors and develops one cooler per rotation of each photoconductor, performs a latent electrostatic image forming step, a developing step, and a transferring step for each color to form a toner image of each color, and the difference between the image forming speed for a single color, and the image forming speed for a full-color is small. Therefore, the tandem image forming apparatus has an advantage that it can correspond to high-speed printing. Since toner images of different colors are formed respectively with different electrophotographic photoconductors, and the toner images are laminated to form a full-color image, a variation in the amount of the toner used for developing among toner particles of different colors, if there are variations in properties, such that charging properties are different between toner particles of different colors, a change in a color tone of a secondary color becomes significant as a result of mixing colors, which lowers color reproducibility. It is therefore important for the toner used in the tandem image forming apparatus that an amount of the toner used for developing is stabilized (there is no variation between toner particles of different colors) to control balance of colors, and a deposition properties to an electrophotographic photoconductor and to a recording medium is uniformed between the toner particles of the different colors. In the light of the aforementioned points, the toner of the present invention is suitable for use in the tandem image forming apparatus.

### <Latent Electrostatic Image Forming Step and Latent Electrostatic Image Forming Unit>

The latent electrostatic image forming step is forming a latent electrostatic image on the latent electrostatic image bearing member, and can be carried out by the latent electrostatic image forming unit. A material, shape, structure or size of the latent electrostatic image bearing member is appropriately selected depending on the intended purpose without any limitation. Examples of the material thereof include: an inorganic material, such as amorphous silicone, and selenium; and an organic material such as polysilane, and phthalopolymethine. Among them, amorphous silicon is preferable in view of its long service life. The shape thereof is preferably a drum shape. The latent electrostatic image forming unit is a unit combining a charging unit, and an exposing unit. The charging unit is appropriately selected depending on the intended purpose without any limitation, and examples thereof include conventional contact chargers known in the art equipped with conductive or semiconductive roller, brush, film, rubber blade, or the like, and conventional non-contact charger using corona discharge such as corotron and scorotron. The exposing unit is appropriately selected depending on the intended purpose without any limitation, and examples thereof include various exposing devices, such as a reproduction optical exposing device, a rod-lens array exposing device, a laser optical exposure device, a liquid crystal shutter optical device, and an LED optical device. Examples of a light source in the exposing device include a light source capable of securing high luminance, such as light emitting diode (LED), laser diode (LD) (i.e. a semiconductor laser), and electroluminescence (EL).

### <Developing Step and Developing Unit>

The developing step can be carried out by the developing unit, and is developing the latent electrostatic image with a toner to form a visible image. The developing unit is appropriately selected depending on the intended purpose without any limitation, provided that it is capable of developing using the toner of the present invention and the developer, but it is preferably a developing unit which houses the developer, and contains a developing device capable of supplying the developer to the latent electrostatic image in a contact or non-contact manner. The developing device may employ a dry developing system, or a wet developing system. Moreover, the developing device may be, a developing device for a single color, or a developing device for multiple colors. Suitable examples of the developing device include a developing device which contains a stirring device configured to stir the developer to cause frictions, to thereby charge the developer, and a magnet roller capable of rotating. In the developing device, for example, the toner of the present invention and the carrier are mixed and stirred, and the toner is charged with the friction caused by the mixing and stirring. The charged toner is held on a surface of a rotating magnetic roller in the state of brush, to thereby form a magnetic brush. The magnet roller is provided adjacent to the electrophotographic photoconductor, and therefore part of the toner of the present invention constituting the magnetic brush on the surface of the magnetic roller is moved to the surface of the electrophotographic photoconductor by electric suction force. As a result, the latent electrostatic image is developed with the toner so that a visible image formed of the toner is formed on the surface of the electrophotographic photoconductor.

### <Transferring Step and Transfer Unit>

The transferring step can be performed by the transfer unit, and is transferring the visible image onto a recording medium. The transfer unit is a unit configured to transfer the visible image onto a recording medium, but the transfer unit employs a method for directly transferring the visible image from the surface of the electrophotographic photoconductor to the recording medium, and a method using an intermediate transfer member, in which the visible image is primary transferred to the intermediate transfer member, followed by secondary transferring the visible image onto the recording medium. It is preferred that the transferring step use the intermediate transfer member, and contain primary transferring the visible image onto the intermediate transfer member, followed by secondary transferring the visible image onto the recording medium. The toner used is typically those of two or more colors, preferably a full-color toner. Therefore, the transferring step preferably contains a primary transferring step, which contains transferring visible images to the intermediate transfer member to form a composite transfer image, and a secondary transferring step, which contains transferring the composite transfer image to a recording medium. Note that, in the secondary transferring step, the linear velocity of the toner image transferred to a recording medium is appropriately selected depending on the intended purpose without any limitation, but it is preferably 300 mm/sec to 1,000 mm/sec. The transfer time at the nip in the secondary transfer unit is appropriately selected depending on the intended purpose without any limitation, but it is preferably 0.5 msec to 20 msec.

### <Fixing Step and Fixing Unit>

The fixing step can be performed by the fixing unit, and is fixing the transfer image transferred to the recording medium. The fixing unit is appropriately selected depending on the intended purpose without any limitation, but it is preferably a heating and pressing member. Examples of the heating and pressing member include a combination of a heating roller and a pressing roller, and a combination of a heating roller, a pressing roller, and an endless belt. The heating is typically preferably performed at temperature of 80° C. to 200° C. For example, the fixing may be performed every time the toner image of each color is transferred to the recording medium, or performed once toner images of all colors have been laminated.

### <Toner Transporting Step and Toner Transporting Unit>

The toner transporting step can be performed by the toner transporting unit, and is supplying a supplemental toner stored in a storing container to the developing unit depending on an amount of the toner consumed by image formation. The toner transporting unit is a unit configured to supply supplemental toner stored in a storing container to the developing unit depending on an amount of the toner consumed by image formation.

### <Other Steps and Other Units>

Other steps and other units are appropriately selected depending on the intended purpose without any limitation, and examples thereof include: a diselectrification step and a diselectrification unit; a cleaning step and a cleaning unit; a recycling step and a recycling unit; and controlling step and a controlling unit.

### —Diselectrification Step and Diselectrification Unit—

The diselectrification step can be performed by the diselectrification unit, and is applying diselectrification bias to the electrophotographic photoconductor to diselectrify. The diselectrification unit is appropriately selected from conventional diselectrification units without any limitation, provided that it is capable of applying diselectrification bias to the electrophotographic photoconductor, and suitable examples thereof include a diselectrification lamp.

### —Cleaning Step and Cleaning Unit—

The cleaning step can be performed by the cleaning unit, and is removing the toner remained on the electrophotographic photoconductor. The cleaning unit is appropriately selected from conventional cleaners without any limitation, provided that it is capable of removing the electrophotographic toner remained on the electrophotographic photoconductor. Preferable examples thereof include a magnetic brush cleaner, an electrostatic brush cleaner, a magnetic roller cleaner, a blade cleaner, a brush cleaner, and a web cleaner.

### —Recycling Step and Recycling Unit—

The recycling step can be performed by the recycling unit, and is recycling the toner removed by the cleaning step to the developing unit. The recycling unit is not particularly limited, and examples thereof include conventional transporting units.

### —Controlling Step and Controlling Unit—

The controlling step can be performed by the controlling unit, and is controlling each step. The controlling unit is appropriately selected depending on the intended purpose without any limitation, provided that it is capable of controlling the operation of each unit, and examples thereof include devices, such as a sequencer, and a computer.

### [Embodiment of Image Forming Apparatus]

An embodiment of the image forming apparatus of the present invention will be explained with reference to drawings hereinafter.

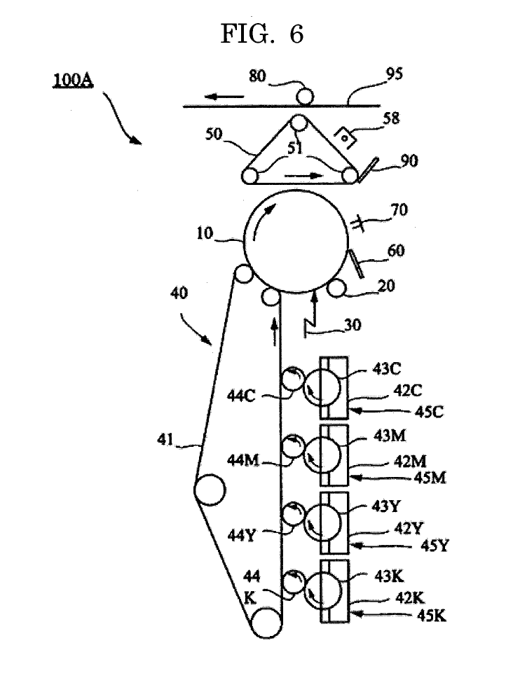

FIG. 6 illustrates one example of the image forming apparatus for use in the present invention. The image forming apparatus 100A is equipped with a photoconductor 10, which is a drum photoconductor image bearing member, a charging device 20, which is a charging unit, an exposing device 30, which is an exposing unit, a developing device 40, which is a developing unit, an intermediate transfer member 50, a cleaning device 60, which is a cleaning unit, and a diselectrification lamp 70, which is a diselectrification unit.

The intermediate transfer member 50 illustrated in FIG. 6 is an endless belt, and is designed to rotate in the direction indicated with an arrow by three rollers 51 disposed inside the intermediate transfer member 50 to support the intermediate transfer member 50. Part of the three rollers 51 also functions as a transfer bias roller capable of applying a predetermined transfer bias (primary transfer bias) to the intermediate transfer member 50. In the surrounding area of the intermediate transfer member 50, the cleaning device 90 having a cleaning blade is provided, and the transfer roller 80 serving as the transfer unit capable of applying a transfer bias for transferring (secondary transferring) a developed image (i.e. the toner image) to the recording medium 95 serving as a final recording medium is provided to face the intermediate transfer member 50. In the surrounding area of the intermediate transfer member 50, the corona charger 58, which is configured to apply a charge to the toner image on the intermediate transfer member 50, is provided in the area situated between the contact area of the photoconductor 10 and the intermediate transfer member 50, and the contact area of the intermediate transfer member 50 and the recording medium 95, in the rotation direction of the intermediate transfer member 50.

The developing device 40 illustrated in FIG. 6 consists of a developing belt 41 serving as the developer bearing member, and a black developing device 45K, a yellow developing device 45Y, a magenta developing device 45M, and a cyan developing device 45C, which are provided next to the developing device 41. The black developing device 45K is equipped with a developer-retention section 42K, a developer supply roller 43K, and a developing roller 44K, the yellow developing device 45Y is equipped with a developer-retention section 42Y, a developer supply roller 43Y, and a developing roller 44Y, the magenta developing unit 45M is equipped with a developer-retention section 42M, a developer supply roller 43M, and a developing roller 44M, and the cyan developing device 45C is equipped with a developer-retention section 42C, a developer supply roller 43C, and a developing roller 44C. Moreover, the developing belt 41 is an endless belt, which is rotatably supported by a plurality of belt rollers, and at part of which is in contact with the photoconductor 10.

The image forming apparatus 100A illustrated in FIG. 6, the charging device 20 uniformly charges the photoconductor 10, followed by exposing the photoconductor 10 using the exposing device 30, to thereby form a latent electrostatic image. Next, the latent electrostatic image formed on the photoconductor 10 is developed with a developer supplied from the developing device 40, to thereby form a toner image. Moreover, the toner image is transferred (primary transferred) to the intermediate transfer member 50 by the voltage applied from the roller 51, and is then transferred (secondary transferred) to a recording medium 95. As a result, a transferred image is formed on the recording medium 95. Note that, the toner remained on the photoconductor 10 is removed by a cleaning device 60 having a cleaning blade, the charge of the photoconductor 10 is removed by the diselectrification lamp 70.

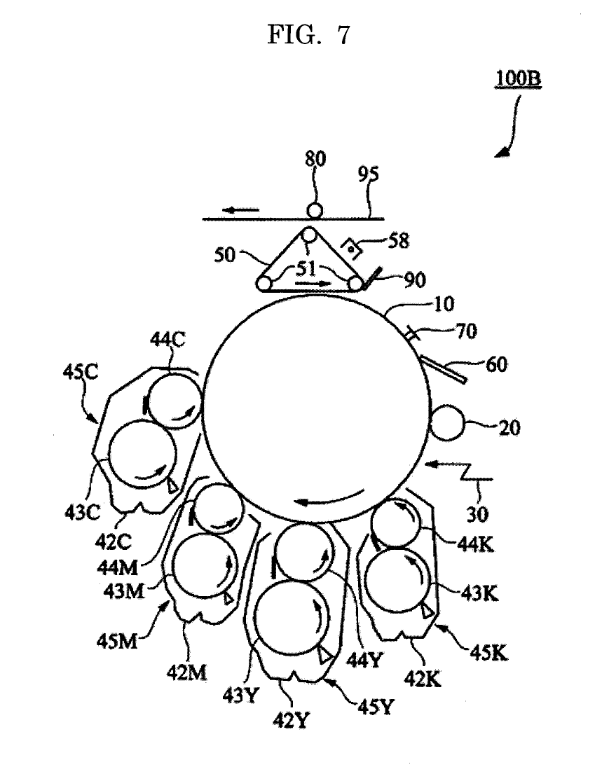

Another example of the image forming apparatus for use in the present invention is illustrated in FIG. 7. The image forming apparatus 100B has the same structure and exhibits the same effect to those of the image forming apparatus 100A, provided that the image forming apparatus 100B is not equipped with a developing belt, and a black developing unit 45K, a yellow developing unit 45Y, a magenta developing unit 45M, and a cyan developing unit 45C are provided to face the photoconductor 10 in a surrounding area of the photoconductor 10. Note that, the reference numbers of FIG. 7, which are also used in FIG. 6, denote the same to those in FIG. 6.

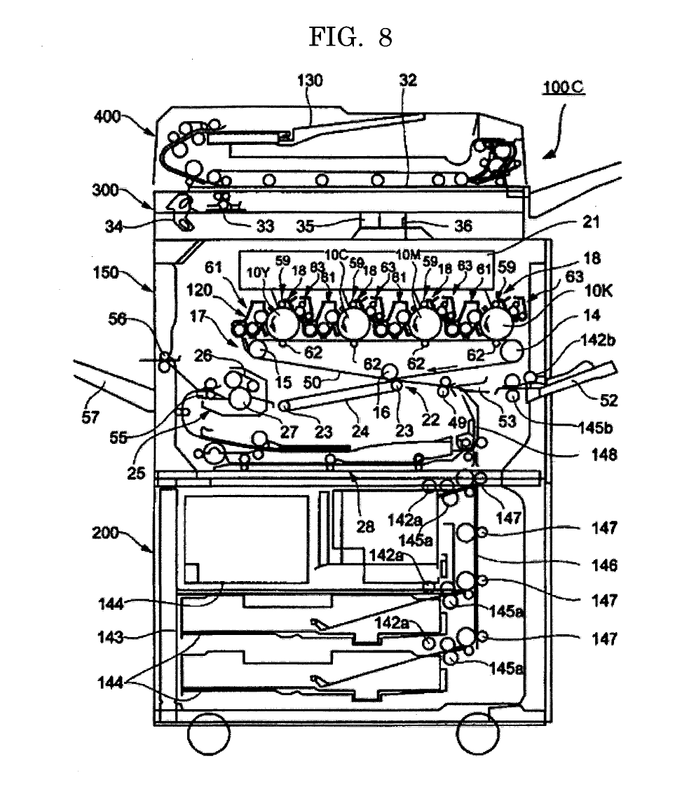

Another example of the image forming apparatus for use in the present invention is illustrated in FIG. 8. The image forming apparatus 100C is a tandem color image forming apparatus. The image forming apparatus 100C is equipped with an apparatus main body 150, a feeding table 200, a scanner 300, and an automatic document feeder (ADF) 400. In the central part of the apparatus main body 150, an intermediate transfer member 50 in the form of an endless belt is provided. The intermediate transfer member 50 is rotatably supported by support rollers 14, 15, and 16 in the clockwise direction in FIG. 8. In the surrounding area of the support roller 15, an intermediate transfer member cleaning device 17 configured to remove the residual toner on the intermediate transfer member 50 is provided. To the intermediate transfer member 50 supported by the support roller 14 and the support roller 15, a tandem developing device 120, in which four image forming units 18, i.e. yellow, cyan, magenta, and black image forming units, are aligned along the traveling direction of the intermediate transfer member 50, is provided. In the surrounding area of the tandem developing device 120, an exposing device 21 is provided. A secondary transfer device 22 is provided at the opposite side of the intermediate transfer member 50 to the side where the tandem developing device 120 is provided. In the secondary transfer device 22, a secondary transfer belt 24, which is an endless belt, is supported by a pair of rollers 23, and is designed so that recording paper transported on the secondary transfer belt 24 and the intermediate transfer member 50 can be in contact with each other. In the surrounding area of the secondary transfer device 22, a fixing device 25 is provided. The fixing device 25 is equipped with a fixing belt 26, which is an endless belt, and a pressure roller 27 disposed so as to press against the fixing belt 26. Note that, in the image forming apparatus 100C, a sheet reverser 28, which is configured to reverse the transfer paper to perform image formation on both sides of the transfer paper, is provided in the surrounding area of the secondary transfer device 22 and the fixing device 25.

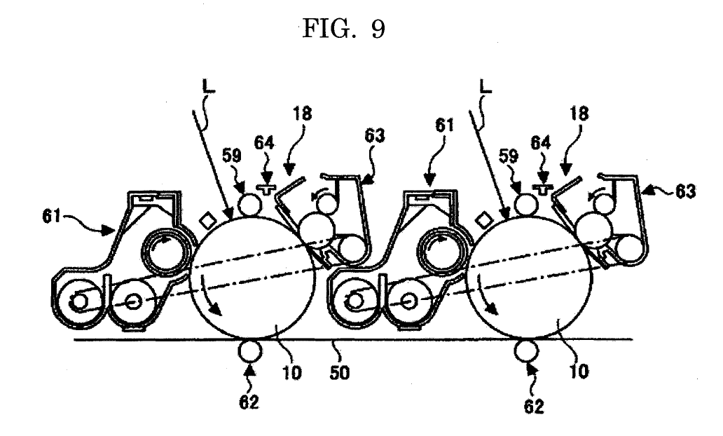

As yet another example of the image forming apparatus for use in the present invention, formation of a full-color image (color copy) using a tandem developing device 120 will be explained with reference to FIG. 9. Note that, the reference numbers of FIG. 9, which are also used in FIG. 8, denote the same as in FIG. 8. The image forming unit 18 of each color in the tandem developing device 120 contains a photoconductor 10, a charger 59 configured to uniformly charge the photoconductor 10, an exposing device 21 configured to apply light (L in FIG. 9) to the photoconductor 10 based on the image information of each color to form a latent electrostatic image on the photoconductor 10, a developing device 61 configured to develop the latent electrostatic image using a toner of each color to form a toner image of each color on the photoconductor 10, a transfer charger 62 configured to transfer the toner image of each color to an intermediate transfer member 50, a photoconductor cleaning device 63, and a diselectrification device 64.

Upon using the tandem developing device 120 illustrated in FIG. 9, first, a document is set on a document table 130 of the automatic document feeder (ADF) 400. Alternatively, the automatic document feeder (ADF) 400 is opened, a document is set on a contact glass 32 of the scanner 300, and then the ADF 400 is closed. In the case where the document is set on the ADF 400, once a start switch (not illustrated) is pressed, the document is transported onto the contact glass 32, and then the scanner 300 is driven to scan the document with a first carriage 33 equipped with a light source and a second carriage 34 equipped with a mirror. In the case where the document is set on the contact glass 32, the scanner 300 is immediately driven in the same manner as mentioned. During this scanning operation, light applied from a light source of the first carriage 33 is reflected on the surface of the document, the reflected light from the document is further reflected by a mirror of the second carriage 34, and passed through an image formation lens 35, which is then received by a read sensor 36. In this manner, the color document (color image) is read, and image information of black, yellow, magenta, and cyan is obtained. The image information of each color, black, yellow, magenta or cyan, is transmitted to respective image forming unit 18 (a black image forming unit, a yellow image forming unit, a magenta image forming unit, and a cyan image forming unit) of the tandem developing device 120, to thereby form a toner image of each color. A toner image formed on the photoconductor for black 10K, a toner image formed on the photoconductor for yellow 10Y, a toner image formed on the photoconductor for magenta 10M, and a toner image formed on the photoconductor for cyan 10C are sequentially transferred (primary transferred) to the intermediate transfer member 50. On the intermediate transfer member 50, the black toner image, the yellow toner image, the magenta toner image, and the cyan toner image are superimposed to form a composite color image (a color transfer image).

In the feeding table 200, one of the feeding rollers 142a is selectively rotated to eject a sheet (recording paper) from one of multiple feeder cassettes 144 of a paper bank 143, the ejected sheets are separated one by one by a separation roller 145 to send to a feeder path 146, and then transported by a transport roller 147 into a feeder path 148 within the apparatus main body 150. The sheet transported in the feeder path 148 is then bumped against a registration roller 49 to stop. Alternatively, sheets (recording paper) on a manual-feeding tray 52 are ejected by rotating a feeding roller 142, separated one by one by a separation roller 145 to guide into a manual feeder path 53, and then bumped against the registration roller 49 to stop. Note that, the registration roller 49 is generally earthed at the time of the use, but it may be biased for removing paper dust of the recording paper. Next, the registration roller 49 is rotated synchronously with the movement of the composite color image (color transfer image) superimposed on the intermediate transfer member 50, to thereby send the recording paper between the intermediate transfer member 50 and the secondary transfer device 22. The recording paper on which the color image has been transferred is transported by a secondary transfer device 22 to send to a fixing device 25. In the fixing device 25, the composite color image (color transfer image) is fixed to the recording paper by heat and pressure. Thereafter, the recording paper is changed its traveling direction by a switch craw 55, ejected by an ejecting roller 56, and then stacked on an output tray 57. Alternatively, the recording paper is changed its traveling direction by the switch craw 55, reversed by the sheet reverser 28 to send to a transfer position, to thereby record an image on the back side thereof. Then, the recording paper is ejected by the ejecting roller 56, and stacked on the output tray 57. Note that, after transferring the image, the residual toner on the intermediate transfer member 50 is cleaned by the intermediate transfer member cleaning device 17.

The preferable embodiment of the present invention has been described above, but the present invention is not limited to the embodiment above, and can be appropriately modified in various manners.

### EXAMPLES

Next, the present invention will be more specifically explained through Examples and Comparative Examples, but Examples shall not be construed as limiting the scope of the present invention. Note that, in Examples below, “part(s)” denotes “part(s) by mass” and “%” denotes “% by mass” unless otherwise stated.

### (Production of External Additive)

External Additives A to T were each produced by mixing primary particles having the average particle diameter as depicted in Table 1 with a treatment agent by spray drying, and firing under the conditions as depicted in Table 1, to thereby make the primary particles coalesced to each other. Moreover, External Additives U to Y were each produced by merely subjecting primary particles having the average particle diameter as depicted in Table 1 to a hydrophobic treatment, without performing a treatment with the treatment agent.

Note that, the treatment agent was prepared by adding 0.1 parts of a treatment aid (water, or 1% acetic acid aqueous solution) to 1 part of methyltrimethoxy silane. The average particle diameter and shape of the secondary particles produced by coalescencing the primary particles are depicted in Table 1.

The measurement of the average particle diameter of the secondary particles was performed by dispersing the secondary particles in tetrahydrofuran, removing the solvent on a substrate to dry and prepare a sample, and measuring the particle diameters of the secondary particles of the sample in the visual field as observed under a field emission scanning electron microscope (FE-SEM, accelerating voltage: 5 kV to 8 kV, magnification: ×8,000 to ×10,000). Specifically, the average particle diameter of the secondary particles was determined by speculating an entire image from a profile of the secondary particle formed by coalescence, and measuring the average value (the number of particles measured: 100 particles or more) of the maximum length (a length of the arrow shown in FIG. 2) of the entire image.

### (Production of Carrier)

The following starting materials of a carrier were dispersed by a Homomixer for 10 minutes, to thereby an acrylic resin-silicone resin coating layer forming solution containing alumina particles. The coating layer forming solution was applied to surfaces of core particles, i.e., baked ferrite powder [(MgO)1.8(MnO)49.5(Fe2O₃)48.0; the weight average particle diameter: 25 μm] by a spira coater (manufactured by OKADA SEIKO CO., LTD.) to give a thickness of 0.15 μm, and the coating solution was dried to thereby obtain a coated ferrite powder. The obtained coated ferrite powder was left and baked in an electric furnace for 1 hour at 150° C. After cooling the ferrite powder, the ferrite powder bulk was crushed using a sieve having an opening size of 106 μm, to thereby obtain a carrier. The film thickness was measured by observing a cross-section of the carrier under a transmission electron microscope to observe a coating layer covering the carrier surface. The coating layer thickness was determined as the average value of the coating layer covering the carrier surface as measured by the observation. In the manner as mentioned, Carrier A having the weight average particle diameter of 35 μM was obtained.

### [Raw Materials of Carrier A]

| | | |
|---|---|---|
| Acrylic resin solution (solid content: 50%) | 21.0 | parts |
| Guanamine resin solution (solid content: 70%) | 6.4 | parts |
| Alumina particles (0.3 μm, specific resistance: | 7.6 | parts |
| 10¹⁴Ω · cm) | | |
| Silicone resin solution (solid content: 23%) | 65.0 | parts |
| [SR2410, manufactured by Dow Corning Toray | | |
| Co., Ltd.] | | |
| Amino silane coupling agent (solid content: | 1.0 | part |
| 100%) [SH6020, manufactured by Dow Corning | | |
| Toray Co., Ltd.] | | |
| Toluene | 60.0 | parts |
| Butyl cellosolve | 60.0 | parts |

### (Evaluation on Cracking or Collapse of Coalesced Particles)

A 50 mL bottle (manufactured by NICHIDEN-RIKA GLASS CO., LTD.) was charged with 50 g of a developer containing 0.5 g of each of External Additives A to T and 49.5 g of Carrier A. The developer was stirred for 10 minutes by means of ROKING MILL (manufactured by SEIWA GIKEN Co., Ltd.) at 67 Hz. The stirred developer was diluted and dispersed in tetrahydrofuran (THF) to separate the external additive to the side of a supernatant, followed by observing under a field emission scanning electron microscope (FE-SEM). From the FE-SEM observation, a ratio (%) of the number of the primary particles relative to 1,000 coalesced particles of External Additives A to T was determined. A photograph of the measuring result in which the ratio of the number of the primary particles is 30% or lower is presented in FIG. 3, and a photograph of the measuring result in which the ratio of the number of the primary particles is higher than 30% is presented in FIG. 4. Note that, during the measurement, the particles which are not coalesced to other primary particles, as indicated with the reference number 4 in FIGS. 3 and 4, were counted as “primary particles” and the ratio was calculated.

TABLE 1-1

| | Production of External Additive | | | | | | | | | |
|---|---|---|---|---|---|---|---|---|---|---|
| | Primary particle | | Production conditions | | | | Secondary particle | | | |
| | | average | | primary particle | | | average | | | |
| | | particle | | treatment agent | | | particle | | Primary | Average |
| | | diameter | treatment | mixing ratio | firing temp. | firing time | diameter | | particle | of degrees of |
| | type | (nm) | agent | (mass ratio) | (° C.) | (h) | (nm) | shape | ratio (%) | coalescence |
| A | silica | 7 | MeSi(OMe)₃ | 100/10 | 800 | 16 | 19 | non-spherical | 16 | 2.71 |
| B | silica | 10 | MeSi(OMe)₃ | 100/10 | 800 | 16 | 22 | non-spherical | 18 | 2.20 |
| C | silica | 70 | MeSi(OMe)₃ | 100/10 | 800 | 16 | 160 | non-spherical | 16 | 2.29 |
| D | silica | 110 | MeSi(OMe)₃ | 100/10 | 800 | 16 | 291 | non-spherical | 14 | 2.65 |
| E | silica | 140 | MeSi(OMe)₃ | 100/10 | 800 | 16 | 320 | non-spherical | 18 | 2.29 |
| F | silica | 7 | MeSi(OMe)₃ | 100/10 | 800 | 8 | 16 | non-spherical | 28 | 2.29 |
| G | silica | 10 | MeSi(OMe)₃ | 100/10 | 800 | 8 | 24 | non-spherical | 26 | 2.40 |
| H | silica | 70 | MeSi(OMe)₃ | 100/1 | 800 | 16 | 163 | non-spherical | 27 | 2.33 |
| I | silica | 110 | MeSi(OMe)₃ | 100/10 | 800 | 8 | 296 | non-spherical | 29 | 2.69 |
| J | silica | 140 | MeSi(OMe)₃ | 100/1 | 800 | 16 | 308 | non-spherical | 27 | 2.20 |

In Table 1-1, A to J denote External Additives A to J, respectively.

TABLE 1-2

| | Production of External Additive | | | | | | | | | |
|---|---|---|---|---|---|---|---|---|---|---|
| | Primary particle | | Production conditions | | | | Secondary particle | | | Degree of coalescence |
| | | average | | primary particle | | | average | | | primary particle |
| | | particle | | treatment agent | firing | firing | particle | | | average particle diameter/ |
| | | diameter | treatment | mixing ratio | temp. | time | diameter | | Primary particle | secondary particle |
| | type | (nm) | agent | (mass ratio) | (° C.) | (h) | (nm) | shape | ratio (%) | average particle diameter |
| K | silica | 7 | MeSi(OMe)₃ | 100/1 | 100 | 8 | 18 | non-spherical | 47 | 2.57 |
| L | silica | 10 | MeSi(OMe)₃ | 100/1 | 100 | 8 | 23 | non-spherical | 48 | 2.30 |
| M | silica | 70 | MeSi(OMe)₃ | 100/1 | 100 | 8 | 154 | non-spherical | 52 | 2.20 |
| N | silica | 110 | MeSi(OMe)₃ | 100/1 | 100 | 8 | 289 | non-spherical | 51 | 2.63 |
| O | silica | 140 | MeSi(OMe)₃ | 100/1 | 100 | 8 | 314 | non-spherical | 59 | 2.24 |
| P | silica | 7 | MeSi(OMe)₃ | 100/10 | 400 | 8 | 14 | non-spherical | 31 | 2.00 |
| Q | silica | 10 | MeSi(OMe)₃ | 100/10 | 400 | 8 | 23 | non-spherical | 32 | 2.30 |
| R | silica | 70 | MeSi(OMe)₃ | 100/10 | 400 | 8 | 168 | non-spherical | 34 | 2.40 |
| S | silica | 110 | MeSi(OMe)₃ | 100/10 | 400 | 8 | 294 | non-spherical | 33 | 2.67 |
| T | silica | 140 | MeSi(OMe)₃ | 100/10 | 400 | 8 | 306 | non-spherical | 32 | 2.19 |
| U | silica | 17 | — | — | — | — | — | spherical | — | — |
| V | silica | 23 | — | — | — | — | — | spherical | — | — |
| W | silica | 178 | — | — | — | — | — | spherical | — | — |
| X | silica | 284 | — | — | — | — | — | spherical | — | — |
| Y | silica | 332 | — | — | — | — | — | spherical | — | — |

In Table 1-2, K to Y denote External Additives K to Y, respectively.

### Synthesis Example 1

### Synthesis of Unmodified Polyester Resin 1

A reaction vessel equipped with a cooling tube, a stirrer, and a nitrogen inlet tube was charged with 67 parts of a bisphenol A ethylene oxide (2 mol) adduct, 84 parts of a bisphenol A propylene oxide (3 mol) adduct, 274 parts of terephthalic acid, and 2 parts of dibutyl tin oxide, and the mixture was allowed to react for 8 hours at 230° C. under atmospheric pressure. Subsequently, the reaction liquid was further reacted for 5 hours under the reduced pressure of 10 mmHg to 15 mmHg, to thereby synthesize Unmodified Polyester Resin 1. Unmodified Polyester Resin 1 had the number average molecular weight (Mn) of 2,100, the weight average molecular weight (Mw) of 5,600, and glass transition temperature (Tg) of 55° C.

### Synthesis Example 2

### Synthesis of Unmodified Polyester Resin 2

A 5 L four necked flask equipped with a nitrogen inlet tube, a condenser, a stirrer, and a thermocouple was charged with 229 parts of a bisphenol A ethylene oxide (2 mol) adduct, 529 parts of a bisphenol A propylene oxide (3 mol) adduct, 208 parts of terephthalic acid, 46 parts of adipic acid, and 2 parts of dibutyl tin oxide, and the mixture was allowed to react for 7 hours at 230° C. under atmospheric pressure, and further reacted for 4 hours under the reduced pressure of 10 mmHg to 15 mmHg. Thereafter, to the flask, 44 parts of trimellitic anhydride was added, and the resulting mixture was allowed to react for 2 hours at 180° C. under atmospheric pressure, to thereby synthesize Unmodified Polyester Resin 2 (non-crystalline polyester resin).

### Synthesis Example 3

### Synthesis of Crystalline Polyester Resin 1

A 5 L four necked flask equipped with a nitrogen inlet tube, a condenser, a stirrer, and a thermocouple was charged with 2,300 parts of 1,6-hexanediol, 2,530 parts of fumaric acid, 291 parts of trimellitic anhydride, and 4.9 parts of hydroquinone, and the mixture was allowed to react for 5 hours at 160° C. Then, the resulting reaction liquid was heated to 200° C., and reacted for 1 hour, followed by further reacting for 1 hour under the pressure of 8.3 kPa to thereby synthesize Crystalline Polyester Resin 1.

### Synthesis Example 4

### Synthesis of Crystalline Polyester Dispersion Liquid 1

A 2 L metal container was charged with 100 parts of Crystalline Polyester Resin 1 and 400 parts ethyl acetate, and the mixture was heated to 75° C. to dissolve Crystalline Polyester Resin 1. Thereafter, the obtained solution was quenched in a ice-water bath at the rate of 27° C./min. To the resultant, 500 mL of glass beads (diameter: 3 mm) was added, and the mixture was subjected to grinding for 10 hours by means of a batch type sand mill (manufactured by Kanpe Hapio Co., Ltd.), to thereby obtain Crystalline Polyester Dispersion Liquid 1.

### Synthesis Example 5

### Synthesis of Master Batch 1

By means of HENSCHEL MIXER (manufactured by Nippon Cole & Engineering Co., Ltd.), 1,000 parts of water, 540 parts of carbon black (Printex35, manufactured by Evonik Degussa Japan Co., Ltd., DBP oil absorption value: 42 ml/100 g, pH: 9.5), and 1,200 parts of Unmodified Polyester Resin 1 were mixed. The resulting mixture was kneaded for 30 minutes at 150° C. with a two-roll kneader, and then was rolled and cooled, followed by pulverized with a pulverizer (manufactured by Hosokawa Micron Corporation), to thereby obtain Master Batch 1.

### Synthesis Example 6

### Synthesis of Master Batch 2

By means of HENSCHEL MIXER (manufactured by Nippon Cole & Engineering Co., Ltd.), 1,200 parts of water, 540 parts of carbon black (Printex35, manufactured by Evonik Degussa Japan Co., Ltd., DBP oil absorption value: 42 ml/100 g, pH: 9.5), and 1,200 parts of Unmodified Polyester Resin 2 were mixed. The resulting mixture was kneaded for 30 minutes at 150° C. with a two-roll kneader, and then was rolled and cooled, followed by pulverized with a pulverizer (manufactured by Hosokawa Micron Corporation), to thereby obtain Master Batch 2.

### Synthesis Example 7

### Synthesis of Polyester Prepolymer 1

A reaction vessel equipped with a cooling tube, a stirrer, and a nitrogen-inlet tube was charged with 682 parts of a bisphenol A ethylene oxide (2 mol) adduct, 81 parts of a bisphenol A propylene oxide (2 mol) adduct, 283 parts of terephthalic acid, 22 parts of trimellitic anhydride, and 2 parts of dibutyl tin oxide, and the resulting mixture was allowed to react for 8 hours at 230° C. under atmospheric pressure, followed by further reacted for 5 hours under the reduced pressure of 10 mmHg to 15 mmHg, to thereby obtain Intermediate Polyester 1. Intermediate Polyester 1 had the number average molecular weight of 2,100, the weight average molecular weight of 9,500, Tg of 55° C., acid value of 0.5, and hydroxyl value of 51. Next, a reaction vessel equipped with a cooling tube, a stirrer, and a nitrogen-inlet tube was charged with 410 parts of Intermediate Polyester 1, 89 parts of isophorone diisocyanate, and 500 parts of ethyl acetate, and the mixture was allowed to react for 5 hours at 100° C., to thereby obtain Polyester Prepolymer 1. Polyester Prepolymer 1 had the free isocyanate rate of 1.53%.

### Synthesis Example 8

### Synthesis of Ketimine Compound 1

A reaction vessel equipped with a stirring bar and a thermometer was charged with 170 parts of isophorone diamine and 75 parts of methyl ethyl ketone, and the mixture was allowed to react for 5 hours at 50° C., to thereby obtain Ketimine Compound 1. Ketimine Compound 1 had the amine value of 418.

### Synthesis Example 9

### Synthesis of Resin Particle Dispersion Liquid 1

A reaction vessel equipped with a stirring bar and a thermometer was charged with 683 parts of water, 16 parts of a sodium salt of sulfuric acid ester of methacrylic acid-ethylene oxide adduct (ELEMINOL RS-30, manufactured by Sanyo Chemical Industries, Ltd.), 83 parts of styrene, 83 parts of methacrylic acid, 110 parts of butyl acrylate, and 1 part of ammonium persulfate, and the resulting mixture was stirred for 15 minutes at 400 rpm to thereby obtain a white emulsion. The obtained emulsion was heated until the internal system temperature reached 75° C., and then was allowed to react for 5 hours. Subsequently, a 1% by mass aqueous ammonium persulfate solution (30 parts) was added to the reaction mixture, followed by aging for 5 hours at 75° C., to thereby prepare Resin Particle Dispersion Liquid 1, which was an aqueous dispersion liquid of a vinyl resin (a copolymer of styrene/methacrylic acid/butyl acrylate/sodium salt of sulfuric acid ester of methacrylic acid ethylene oxide adduct). Resin Particle Dispersion Liquid 1 had the volume average particle diameter (as measured by LA-920, manufactured by Horiba, Ltd.) of 9 nm.

### Synthesis Example 10

### Synthesis of Resin Particle Dispersion Liquid 2

A reaction vessel equipped with a stirring bar and a thermometer was charged with 683 parts of water, 11 parts of a sodium salt of sulfuric acid ester of methacrylic acid-ethylene oxide adduct (ELEMINOL RS-30, manufactured by Sanyo Chemical Industries, Ltd.), 138 parts of styrene, 138 parts of methacrylic acid, and 1 part of ammonium persulfate, and the resulting mixture was stirred for 15 minutes at 400 rpm to thereby obtain a white emulsion. The obtained emulsion was heated until the internal system temperature reached 75° C., and then was allowed to react for 5 hours. Subsequently, a 1% by mass aqueous ammonium persulfate solution (30 parts) was added to the reaction mixture, followed by aging for 5 hours at 75° C., to thereby prepare Resin Particle Dispersion Liquid 2, which was an aqueous dispersion liquid of a vinyl resin (a copolymer of styrene/methacrylic acid/butyl acrylate/sodium salt of sulfuric acid ester of methacrylic acid ethylene oxide adduct). Resin Particle Dispersion Liquid 2 had the volume average particle diameter (as measured by LA-920) of 0.14 μm. Part of Resin Particle Dispersion Liquid 2 was dried to isolate a resin component.

### Example 1

### Oil Phase Preparation Step

A beaker was charged with 100 parts of Unmodified Polyester Resin 1 and 130 parts of ethyl acetate, and the mixture was stirred to dissolve Unmodified Polyester Resin 1. To this, 10 parts of carnauba wax (molecular weight: 1,800, acid value: 2.5, penetration degree: 1.5 mm (40° C.)), and 10 parts of Master Batch 1 were added, and the resulting mixture was dispersed by means of a bead mill (ULTRA VISCOMILL, manufactured by AIMEX CO., Ltd.) under the conditions: a liquid feed rate of 1 kg/hr, disc circumferential velocity of 6 m/s, 0.5 mm-zirconia beads packed to 80% by volume, and 3 passes to prepare a raw material solution, to thereby obtain Oil Phase 1 (a solution or dispersion of toner material).

### <Aqueous Phase Preparation Step>

Water (660 parts), 25 parts of Resin Particle Dispersion Liquid 1, 25 parts of a 48.5% sodium dodecyldiphenyl ether disulfonate aqueous solution (ELEMINOL MON-7, product of Sanyo Chemical Industries Ltd.), and 60 parts of ethyl acetate were mixed and stirred, to thereby obtain Aqueous Phase 1 (a milky white fluid).

### <Emulsification or Dispersion Step>

A vessel was charged with 150 parts of Aqueous Phase 1, and Aqueous Phase 1 was stirred by TK Homomixer (manufactured by PRIMIX Corporation) at 12,000 rpm. To this, 100 parts of Oil Phase 1 was added, and the mixture was mixed for 10 minutes to thereby prepare Emulsified Slurry 1 (an emulsion or dispersion liquid).

### <Solvent Removing Step>

A flask equipped with a deaeration pipe, a stirrer, and a thermometer wash charged with 100 parts of Emulsified Slurry 1, and the solvent therein was removed by stirring for 12 hours at the stirring rim speed of 20 m/min at 30° C. under the reduced pressure, to thereby obtain Desolvent Slurry 1.

### <Washing and Drying Step>

The entire amount of Desolvent Slurry 1 was subjected to filtration under the reduced pressure, and 300 parts of ion-exchanged water was added to the resulting filtration cake. The obtained mixture was mixed and re-dispersed (at 12,000 rpm for 10 minutes) by TK Homomixer, followed by subjecting the resultant to filtration. To the obtained filtration cake, 300 parts of ion-exchanged water was added, and the mixture was mixed by TK Homomixer (at 12,000 rpm for 10 minutes), followed by filtration, the series of which were performed three times. The obtained washed slurry was aged for 10 hours at 45° C., and the resultant was subjected to filtration, to thereby obtain a heat treated cake. The heat treated cake was dried by means of a wind dryer for 48 hours at 45° C. The resultant was sieved with a mesh having an opening size of 75 μm, to thereby obtain Toner Base Particles 1.

### <External Additive Treating Step>

To 100 parts of Toner Base Particles 1, 2.0 parts of External Additive A, 2.0 parts of silica having the volume average particle diameter of 20 nm (manufactured by Nippon Aerosil Co., Ltd.), 0.6 parts of titanium oxide having the volume average particle diameter of 20 nm (manufactured by TAYCA CORPORATION) were added, and the mixture was mixed by HENSCHEL MIXER. The resultant was passed through a sieve with a mesh opening size of 500, to thereby obtain Toner 1.

### Examples 2 to 10

Toner 2 to Toner 10 were produced in the same manner as in Example 1, provided that External Additive A was replaced to External Additives B to J depicted in Table 2, respectively.

### Example 11

### Oil Phase Preparation Step

A vessel equipped with a stirring bar and a thermometer was charged with 378 parts of Unmodified Polyester Resin 2, 110 parts of carnauba wax, 22 parts of a charge controlling agent (CCA, salicylic acid metal complex E-84, manufactured by Orient Chemical Industries, Ltd.), and 947 parts of ethyl acetate. The resulting mixture was heated to 80° C. with stirring, and the temperature was kept at 80° C. for 5 hours, followed by cooling to 30° C. over 1 hour. Next, a vessel was charged with 500 parts by mass of Master Batch 2, and 500 parts by mass of ethyl acetate, and the mixture was mixed for 1 hour to thereby obtain Raw Material Solution 2. Raw Material Solution 2 (1,324 parts) was transferred to a vessel, and the carbon black and wax were dispersed y means of a bead mill (ULTRA VISCOMILL, manufactured by AIMEX CO., Ltd.) under the conditions: a liquid feed rate of 1 kg/hr, disc circumferential velocity of 6 m/s, 0.5 mm-zirconia beads packed to 80% by volume, and 3 passes. To the resultant, 1,042.3 parts by mass of a 65% by mass Unmodified Polyester Resin 2 ethyl acetate solution was added, and the resultant was dispersed by the bead mill once under the conditions described above, to thereby obtain Oil Phase 2. Oil Phase 2 had the solid concentration (130° C., 30 minutes) of 50%.

### <Aqueous Phase Preparation Step>

Water (990 parts), 83 parts of Resin Particle Dispersion Liquid 2, 37 parts of a 48.5% sodium dodecyldiphenyl ether disulfonate aqueous solution (ELEMINOL MON-7, product of Sanyo Chemical Industries Ltd.), and 90 parts of ethyl acetate were mixed and stirred, to thereby obtain Aqueous Phase 2 (a milky white fluid).

### <Emulsification or Dispersion Step>

A vessel was charged with 664 parts of Oil Phase 2, 109.4 parts of Polyester Prepolymer 1, 73.9 parts of Crystalline Polyester Dispersion Liquid 1, and 4.6 parts of Ketimine Compound 1. The resulting mixture was mixed by means of TK Homomixer (manufactured by PRIMIX Corporation) for 1 minute at 5,000 rpm. To the vessel, 1,200 parts of Aqueous Phase 2 was further added, and the resulting mixture was mixed by means of TK Homomixer for 20 minutes at 13,000 rpm, to thereby obtain Emulsified Slurry 2.

### <Solvent Removing Step>

A vessel equipped with a stirrer and a thermometer was charged with Emulsified Slurry 2. The solvent therein was removed for 8 hours at 30° C., followed by aging for 4 hours at 45° C., to thereby obtain Dispersion Slurry 2.

### <Washing and Drying Step>

After filtering 100 parts by mass of Dispersion Slurry 2, the following operations (1) to (4) were performed twice, to thereby obtain Filtration Cake 2.

(1): To the filtration cake, 100 parts by mass of ion-exchanged water was added, and the mixture was mixed (at 12,000 rpm for 10 minutes) by the TK Homomixer, followed by filtering the mixture.
(2): To the filtration cake obtained in (1), 100 parts by mass of a 10% by mass sodium hydroxide aqueous solution was added, and the mixture was mixed (at 12,000 rpm for 30 minutes) by the TK Homomixer, followed by filtering the mixture under the reduced pressure.
(3): To the filtration cake obtained in (2), 100 parts by mass of 10% by mass hydrochloric acid was added, and the mixture was mixed (at 12,000 rpm for 10 minutes) by the TK Homomixer, followed by filtering the mixture.
(4): To the filtration cake obtained in (3), 300 parts by mass of ion-exchanged water was added, and the mixture was mixed (at 12,000 rpm for 10 minutes) by the TK Homomixer, followed by filtering the mixture. Filtration Cake 2 was dried with an air-circulating drier for 48 hours at 45° C., and was then passed through a sieve with a mesh size of 75 μm, to thereby prepare Toner Base Particles 2.

### <External Additive Treating Step>

To 100 parts of Toner Base Particles 2, 2.0 parts of External Additive A, 2.0 parts of silica having the volume average particle diameter of 20 nm (manufactured by Nippon Aerosil Co., Ltd.), 0.6 parts of titanium oxide having the volume average particle diameter of 20 nm (manufactured by TAYCA CORPORATION) were added, and the mixture was mixed by HENSCHEL MIXER. The resultant was passed through a sieve with a mesh opening size of 500, to thereby obtain Toner 11.

### Examples 12 to 20

Toner 12 to Toner 20 were each obtained in the same manner as in Example 11, provided that External Additive A was replaced with External Additives B to J as depicted in Table 2, respectively.

### Example 21

After sufficiently stirring and mixing 80 parts of Unmodified Polyester Resin 1, 5 parts of paraffin wax (HNP-9, manufactured by NIPPON SEIRO CO., LTD., melting point: 75° C.), and 10 parts of Master Batch 1 in HENSCHEL MIXER, the resulting mixture was heated and melted for 30 minutes at 130° C. by a roll mill, followed by cooling to room temperature. The obtained kneaded product was roughly pulverized into 200 μm to 400 μm by a hammer mill. Next, the pulverized product was further pulverized and classified by means of a pulverizing classification device (manufactured by Nippon Pneumatic Mfg. Co., Ltd.) having integratedly a fine pulverizer configured to finely pulverize by making the roughly pulverized product directly crash into a crashing board by jet stream, and a wind classification device configured to form turning flow of the finely pulverized powder obtained by the fine pulverizer within the classification chamber, and to centrifugal separate the pulverized product to classify. As a result, the classified Toner Base Particles 3 were obtained. Toner Base Particles 3 (100 parts) was mixed with 2.0 parts of External Additive A, 2.0 parts of silica having the volume average particle diameter of 20 nm (manufactured by Nippon Aerosil Co., Ltd.), and 0.6 parts of titanium oxide having the volume average particle diameter of 20 nm (manufactured by TAYCA CORPORATION) by means of HENSCHEL MIXER, and the resultant was passed through a sieve with a mesh opening size of 500, to thereby obtain Toner 21.

### Examples 22 to 30

Toner 22 to Toner 30 were produced in the same manner as in Example 21, provided that External Additive A was replaced with External Additives B to J depicted in Table 2, respectively.

### Example 31

After sufficiently stirring and mixing 70 parts of Unmodified Polyester Resin 1, 10 parts of Crystalline Polyester Resin 1, 5 parts of paraffin wax (HNP-9, manufactured by NIPPON SEIRO CO., LTD., melting point: 75° C.), and 10 parts of Master Batch 1, the resulting mixture was heated and melted for 30 minutes at 130° C. by a roll mill, followed by cooling to room temperature. The obtained kneaded product was roughly pulverized into 200 μm to 400 μm by a hammer mill. Next, the pulverized product was further pulverized and classified by means of IDS-2, a pulverizing classification device (manufactured by Nippon Pneumatic Mfg. Co., Ltd.) having integratedly a fine pulverizer configured to finely pulverize by making the roughly pulverized product directly crash into a crashing board by jet stream, and a wind classification device configured to form turning flow of the finely pulverized powder obtained by the fine pulverizer within the classification chamber, and to centrifugal separate the pulverized product to classify. As a result, the classified Toner Base Particles 4 were obtained. Toner Base Particles 4 (100 parts) was mixed with 2.0 parts of External Additive A, 2.0 parts of silica having the volume average particle diameter of 20 nm (manufactured by Nippon Aerosil Co., Ltd.), and 0.6 parts of titanium oxide having the volume average particle diameter of 20 nm (manufactured by TAYCA CORPORATION) by means of HENSCHEL MIXER, and the resultant was passed through a sieve with a mesh opening size of 500, to thereby obtain Toner 31.

### Examples 32 to 40

Toner 32 to Toner 40 were produced in the same manner as in Example 31, provided that External Additive A was replaced with External Additives B to J depicted in Table 2, respectively.

### Comparative Examples 1 to 15

Toner 41 to Toner 55 were produced in the same manner as in Example 1, provided that External Additive A was replaced with External Additives K to Y as depicted in Table 2, respectively.

### (Production of Two-Component Developer)

Each toner produced in Examples and Comparative Examples and Carrier A were used. Each toner (7 parts) was uniformly mixed with 100 parts of Carrier A by means of a tubular mixer which was configured to drive a container in a rolling motion to stir, and the toner and the carrier were charged to thereby produce a two-component developer.

### (Comprehensive Evaluation)

The results of the comprehensive evaluation on each developer using each toner produced in Examples and Comparative Examples are presented in Table 2.

### <Total Judgment>

The total judgment was made based on the evaluation results, and “I” and “II” were judged as usable, and “III” was judged as unusable.

### [Evaluation Criteria]

I: There were two or more “A or I” in the results from evaluation items, and no “D or III.”

II: There was one or no “A or I” in the results from evaluation items, and no “D or III.”

III: There were one or more “D or III.”

### <Transfer Property>

Using a digital full-color image forming apparatus (imagio MPC6000, manufactured by Ricoh Company Limited), a chart having an imaging area of 20% was transferred from a photoconductor to paper. Thereafter, the residual toner on the photoconductor just before cleaning was transferred to white paper with Scotch Tape (manufactured by Sumitomo 3M Ltd.), and the resultant was measured by Macbeth reflection densitometer RD514. The results were evaluated based on the following criteria. Note that, “A”, “B” and “C” were judged as acceptable, and “D” was judged as unacceptable.

### [Evaluation Criteria]

A: A difference with blank was less than 0.005.

B: A difference with blank was 0.005 or more but less than 0.010.

C: A difference with blank was 0.010 or more but less than 0.020.

D: A difference with blank was 0.020 or more.

### <Cleaning Property>

Using a digital full-color image forming apparatus (imagio MPC6000, manufactured by Ricoh Company Limited), printing was performed. After a initial stage, printing 1,000 sheets, and printing 100,000 sheets, the residual toner on the photoconductor which had been gone through a cleaning step was transferred to white paper with Scotch Tape (manufactured by Sumitomo 3M Ltd.), and the resultant was measured by Macbeth reflection densitometer RD514. The results were evaluated based on the following criteria. Note that, “A”, “B” and “C” were judged as acceptable, and “D” was judged as unacceptable.

### [Evaluation Criteria]

A: A difference with blank was less than 0.005.

B: A difference with blank was 0.005 or more but less than 0.010.

C: A difference with blank was 0.010 or more but less than 0.020.

D: A difference with blank was 0.020 or more.

### <Storage Stability>

After storing the toner in the environment having the temperature of 40° C. and the relative humidity of 70% RH for 2 weeks, the toner was sieved with a sieve having a mesh size of 200 for 1 minute, and a remaining rate of the toner on the mesh was measured. The results were evaluated based on the following criteria. The smaller the residual rate of the toner is, more excellent storage stability is. Note that, “A”, “B” and “C” were judged as acceptable, and “D” was judged as unacceptable.

### [Evaluation Criteria]

A: The residual rate was less than 0.1%.

B: The residual rate was 0.1% or more but less than 0.5%.

C: The residual rate was 0.5% or more but less than 1.0%.

D: The residual rate was 1.0% or more.

### <Image Density>

Using a digital full-color image forming apparatus (imagio MPC6000, manufactured by Ricoh Company Limited), an image chart having an imaging area of 20% was printed on 150,000 sheets, followed by printing a solid image on 6,000 sheets. Thereafter, the image density of the output sheets was measured by means of a color reflection densitometer (of X-Rite). The image densities of solids images of 4 colors were respectively measured, and the average value thereof was obtained. The results were evaluated based on the following criteria. This test was performed both in the high temperature and high humidify environment (27° C., 80% RH), and in the low temperature and low humidity environment (10° C., 15% RH). Note that, “I” and “II” were judged as acceptable, and “III” was judged as unacceptable.

### [Evaluation Criteria]

I: 1.4 or more but less than 1.8

II: 1.1 or more but less than 1.4

III: less than 1.1

TABLE 2-1

| | | | | Evaluation | | | | |
|---|---|---|---|---|---|---|---|---|
| | Toner | | | Transfer | Cleaning | Storage | Image | Total |
| | Toner | Toner base particles | EA* | property | property | stability | density | judgement |
| Ex. 1 | Toner 1 | Toner Base Particles 1 | EA A | B | B | B | I | II |
| Ex. 2 | Toner 2 | Toner Base Particles 1 | EA B | A | B | A | I | I |
| Ex. 3 | Toner 3 | Toner Base Particles 1 | EA C | A | A | A | I | I |
| Ex. 4 | Toner 4 | Toner Base Particles 1 | EA D | A | B | A | I | I |
| Ex. 5 | Toner 5 | Toner Base Particles 1 | EA E | B | B | B | I | II |
| Ex. 6 | Toner 6 | Toner Base Particles 1 | EA F | C | C | C | II | II |
| Ex. 7 | Toner 7 | Toner Base Particles 1 | EA G | B | B | B | II | II |
| Ex. 8 | Toner 8 | Toner Base Particles 1 | EA H | A | B | A | II | I |
| Ex. 9 | Toner 9 | Toner Base Particles 1 | EA I | B | B | B | II | II |
| Ex. 10 | Toner 10 | Toner Base Particles 1 | EA J | C | C | C | II | II |
| Ex. 11 | Toner 11 | Toner Base Particles 2 | EA A | B | B | B | I | II |
| Ex. 12 | Toner 12 | Toner Base Particles 2 | EA B | A | B | A | I | I |
| Ex. 13 | Toner 13 | Toner Base Particles 2 | EA C | A | A | A | I | I |
| Ex. 14 | Toner 14 | Toner Base Particles 2 | EA D | A | B | A | I | I |
| Ex. 15 | Toner 15 | Toner Base Particles 2 | EA E | B | B | B | I | II |
| Ex. 16 | Toner 16 | Toner Base Particles 2 | EA F | C | C | C | II | II |
| Ex. 17 | Toner 17 | Toner Base Particles 2 | EA G | B | B | B | II | II |
| Ex. 18 | Toner 18 | Toner Base Particles 2 | EA H | A | B | A | II | I |
| Ex. 19 | Toner 19 | Toner Base Particles 2 | EA I | B | B | B | II | II |
| Ex. 20 | Toner 20 | Toner Base Particles 2 | EA J | C | C | C | II | II |
| Ex. 21 | Toner 21 | Toner Base Particles 3 | EA A | B | A | B | II | II |
| Ex. 22 | Toner 22 | Toner Base Particles 3 | EA B | B | A | B | II | II |
| Ex. 23 | Toner 23 | Toner Base Particles 3 | EA C | B | A | B | II | II |
| Ex. 24 | Toner 24 | Toner Base Particles 3 | EA D | B | A | B | II | II |
| Ex. 25 | Toner 25 | Toner Base Particles 3 | EA E | B | A | B | II | II |
| Ex. 26 | Toner 26 | Toner Base Particles 3 | EA F | C | B | C | II | II |
| Ex. 27 | Toner 27 | Toner Base Particles 3 | EA G | C | B | C | II | II |
| Ex. 28 | Toner 28 | Toner Base Particles 3 | EA H | C | A | C | II | II |
| Ex. 29 | Toner 29 | Toner Base Particles 3 | EA I | C | B | C | II | II |
| Ex. 30 | Toner 30 | Toner Base Particles 3 | EA J | C | B | C | II | II |
| Ex. 31 | Toner 31 | Toner Base Partides 4 | EA A | B | A | B | II | II |
| Ex. 32 | Toner 32 | Toner Base Particles 4 | EA B | B | A | B | II | II |
| Ex. 33 | Toner 33 | Toner Base Particles 4 | EA C | B | A | B | II | II |
| Ex. 34 | Toner 34 | Toner Base Particles 4 | EA D | B | A | B | II | II |
| Ex. 35 | Toner 35 | Toner Base Particles 4 | EA E | B | A | B | II | II |
| Ex. 36 | Toner 36 | Toner Base Particles 4 | EA F | C | B | C | II | II |
| Ex. 37 | Toner 37 | Toner Base Particles 4 | EA G | C | B | C | II | II |
| Ex. 38 | Toner 38 | Toner Base Particles 4 | EA H | C | A | C | II | II |
| Ex. 39 | Toner 39 | Toner Base Particles 4 | EA I | C | B | C | II | II |
| Ex. 40 | Toner 40 | Toner Base Particles 4 | EA J | C | B | C | II | II |

*“EA” is an abbreviation of “external additive”.

TABLE 2-2

| | Toner | | | Evaluation | | | | |
|---|---|---|---|---|---|---|---|---|
| | | Toner base | External | Transfer | Cleaning | Storage | Image | Total |
| | Toner | particles | additive | property | property | stability | density | judgment |
| Comp. | Toner | Toner Base | External | D | D | D | III | III |
| Ex. 1 | 41 | Particles 1 | Additive K | | | | | |
| Comp. | Toner | Toner Base | External | D | C | D | III | III |
| Ex. 2 | 42 | Particles 1 | Additive L | | | | | |
| Comp. | Toner | Toner Base | External | D | B | D | III | III |
| Ex. 3 | 43 | Particles 1 | Additive M | | | | | |
| Comp. | Toner | Toner Base | External | D | B | D | III | III |
| Ex. 4 | 44 | Particles 1 | Additive N | | | | | |
| Comp. | Toner | Toner Base | External | D | B | D | III | III |
| Ex. 5 | 45 | Particles 1 | Additive O | | | | | |
| Comp. | Toner | Toner Base | External | D | D | D | III | III |
| Ex. 6 | 46 | Particles 1 | Additive P | | | | | |
| Comp. | Toner | Toner Base | External | C | C | C | III | III |
| Ex. 7 | 47 | Particles 1 | Additive Q | | | | | |
| Comp. | Toner | Toner Base | External | C | B | C | III | III |
| Ex. 8 | 48 | Particles 1 | Additive R | | | | | |
| Comp. | Toner | Toner Base | External | C | B | C | III | III |
| Ex. 9 | 49 | Particles 1 | Additive S | | | | | |
| Comp. | Toner | Toner Base | External | D | B | D | III | III |
| Ex. 10 | 50 | Particles 1 | Additive T | | | | | |
| Comp. | Toner | Toner Base | External | D | D | D | III | III |
| Ex. 11 | 51 | Particles 1 | Additive U | | | | | |
| Comp. | Toner | Toner Base | External | D | C | B | III | III |
| Ex. 12 | 52 | Particles 1 | Additive V | | | | | |
| Comp. | Toner | Toner Base | External | D | C | B | III | III |
| Ex. 13 | 53 | Particles 1 | Additive W | | | | | |
| Comp. | Toner | Toner Base | External | D | C | B | III | III |
| Ex. 14 | 54 | Particles 1 | Additive X | | | | | |
| Comp. | Toner | Toner Base | External | D | C | B | III | III |
| Ex. 15 | 55 | Particles 1 | Additive Y | | | | | |

The toner of the present invention gives excellent cleaning ability, storage stability, and image density, has high durability, and gives excellent image quality upon usage of a long term, as well as exhibiting excellent transfer property upon high-speed full-color image formation, and therefore the toner of the present invention can be suitably used in image formation of an electrophotographic system using a photocopier, electrostatic printing, a printer, a facsimile, and electrostatic recording.

Aspects of the present invention are as follows, for example.

<1> A toner including:

toner base particles; and

an external additive,

the toner base particles each including a binder resin and a releasing agent,

wherein the external additive includes non-spherical coalesced particles in each of which primary particles are coalesced together, and

wherein the coalesced particles satisfy the following formula (1):

$$\frac{Nx}{1 , 000} \times 100 \leq 30 \% \qquad Formula ( 1 )$$

where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

<2> The toner according to <1>,

wherein the coalesced particles satisfy the following formula (1-1):

$$\frac{Nx}{1 , 000} \times 100 \leq 20 \% \qquad Formula ( 1 \text{-} 1 )$$

where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

<3> The toner according to <1> or <2>,

wherein the coalesced particles have an average particle diameter of 15 nm to 400 nm.

<4> The toner according to any one of <1> to <3>,

wherein the coalesced particles include silica.

<5> The toner according to any one of <1> to <4>,

wherein the toner base particles each include a crystalline resin.

<6> The toner according to any one of <1> to <5>,

wherein the toner base particles are obtained through a process including: dissolving or dispersing at least the binder resin and the releasing agent in an organic solvent to prepare a solution or a dispersion; adding the solution or the dispersion to an aqueous phase to prepare a dispersion liquid; and removing the organic solvent from the dispersion liquid.

<7> The toner according to any one of <1> to <6>,

wherein the binder resin includes a polyester resin.

<8> A developer including:

the toner according to any one of <1> to <7>; and

a carrier.

<9> An image forming apparatus including:

a latent electrostatic image bearing member;

a latent electrostatic image forming unit configured to form a latent electrostatic image on the latent electrostatic image bearing member;

a developing unit, which houses the toner according to any one of <1> to <7>, or the developer according to <8>, and is configured to develop the latent electrostatic image to form a visible image;

a transfer unit configured to transfer the visible image onto a recording medium; and

a fixing unit configured to fix the visible image transferred onto the recording medium.

<10> The image forming apparatus according to <9>,

wherein the image forming apparatus is capable of forming images at the speed of 55 sheets/min or faster with the recording medium of A4 size, where the recording medium is fed in a direction along the shorter side of the recording medium.

### REFERENCE SIGNS LIST

1A primary particle
1B primary particle
1C primary particle
1D primary particle
3 coalesced particles
4 primary particle
10 photoconductor
18 image forming unit
20 charging device
22 transferring device
25 fixing device
30 exposing device
40 developing device
95 recording medium
100A image forming apparatus
100B image forming apparatus
100C image forming apparatus

1. A toner comprising:
toner base particles; and
an external additive,
the toner base particles each comprising a binder resin and a releasing agent,
wherein the external additive comprises non-spherical coalesced particles in each of which primary particles are coalesced together, and
wherein the coalesced particles satisfy the following formula (1):
$$\frac{Nx}{1 , 000} \times 100 \leq 30 \% \qquad Formula ( 1 )$$
where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

2. The toner according to claim 1,
wherein the coalesced particles satisfy the following formula (1-1):
$$\frac{Nx}{1 , 000} \times 100 \leq 20 \% \qquad Formula ( 1 \text{-} 1 )$$
where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

3. The toner according to claim 1,
wherein the coalesced particles have an average particle diameter of 15 nm to 400 nm.

4. The toner according to claim 1, wherein the coalesced particles comprise silica.

5. The toner according to claim 1, wherein the toner base particles each comprise a crystalline resin.

6. The toner according to claim 1, wherein the toner base particles are obtained through a process comprising:
dissolving or dispersing at least the binder resin and the releasing agent in an organic solvent to prepare a solution or a dispersion;
adding the solution or the dispersion to an aqueous phase to prepare a dispersion liquid; and
removing the organic solvent from the dispersion liquid.

7. The toner according to claim 1, wherein the binder resin comprises a polyester resin.

8. A developer comprising:
a toner; and
a carrier,
wherein the toner comprises:
toner base particles; and
an external additive,
the toner base particles each comprising a binder resin and a releasing agent,
wherein the external additive comprises non-spherical coalesced particles in each of which primary particles are coalesced together, and
wherein the coalesced particles satisfy the following formula (1):
$$\frac{Nx}{1 , 000} \times 100 \leq 30 \% \qquad Formula ( 1 )$$
where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

9. An image forming apparatus comprising:
a latent electrostatic image bearing member;
a latent electrostatic image forming unit configured to form a latent electrostatic image on the latent electrostatic image bearing member;
a developing unit, which houses a toner, and is configured to develop the latent electrostatic image to form a visible image;
a transfer unit configured to transfer the visible image onto a recording medium; and
a fixing unit configured to fix the visible image transferred onto the recording medium,
wherein the toner comprises:
toner base particles; and
an external additive,
the toner base particles each comprising a binder resin and a releasing agent,
wherein the external additive comprises non-spherical coalesced particles in each of which primary particles are coalesced together, and
wherein the coalesced particles satisfy the following formula (1):
$$\frac{Nx}{1 , 000} \times 100 \leq 30 \% \qquad Formula ( 1 )$$
where Nx is a number of the primary particles present alone relative to 1,000 of the coalesced particles, as observed under a scanning electron microscope after stirring 0.5 g of the coalesced particles and 49.5 g of a carrier placed in a 50 mL bottle for 10 minutes by means of a mixing and stirring device at 67 Hz.

10. The image forming apparatus according to claim 9,
wherein the image forming apparatus is capable of forming images at the speed of 55 sheets/min or faster with the recording medium of A4 size, where the recording medium is fed in a direction along the shorter side of the recording medium.
